(19) United States
(12) Patent Application Publication
(10) Pub. No.: US 2026/0127928 A1
(43) Pub. Date: May 7, 2026

(54) WATERMARKED LIVE STREAM AS ACCESS TOKEN IN EVENT MANAGEMENT SYSTEM

(71) Applicant: Live Nation Entertainment, Inc., Beverly Hills, CA (US)

(72) Inventor: David B. Johnson, San Marino, CA (US)

(73) Assignee: Live Nation Entertainment, Inc., Beverly Hills, CA (US)

(21) Appl. No.: 19/381,835

(22) Filed: Nov. 6, 2025

Related U.S. Application Data
(60) Provisional application No. 63/717,214, filed on Nov. 6, 2024.

(51) Int. Cl. G07C 9/27; G06Q 30/0251; G07C 9/29

(52) U.S. Cl. CPC G07C 9/27; G06Q 30/0269; G07C 9/29

(57) ABSTRACT

An event management system includes an access management server that receives over a network, a request from a user via a user device for an access right for an event. In response, data encoded in a audio and/or video stream is provided to the user device. The data includes an entry token associated with the access right for the event. The user device scans the stream for authorization at a kiosk or a venue entrance of the event. A scanner located adjacent to the venue entrance, detects the stream provided by the user device. The access management server coupled to the scanner decodes the data encoded in the stream. The data includes the entry token. The access right is authorized for the user based on information decoded from the stream for entry to the event.

### PRIORITY

This application is a non-provisional of and claims priority to U.S Provisional Patent Application No. 63/717,214, filed November 6, 2024, the contents of which is incorporated herein by reference in its entirety.

### BACKGROUND

This disclosure relates, in general, to providing audio or video-based access tokens for a live event inside a venue.

Access tokens or digital tickets (for example, barcode tickets) are generally used for access to events taking place at venues. Attending live events such as concerts, sports games, or theatre performances has become a popular activity for people worldwide. However, the traditional process of physically checking the access tokens or scanning mobile tokens or barcodes to check-in to these events is prone to security concerns. Often, these tickets can be misused by illegally acquiring the access tokens. For example, the barcodes can be unauthorizedly copied. Moreover, the traditional ticketing process may not be secure enough to overcome these issues.

In recent years, technological advancements have made it possible to simplify the check-in process and improve the overall experience for event attendees. For example, rotating barcodes in which the barcodes change frequently so that the barcodes are not copied easily. The rotating barcodes reduce the security risks associated with barcode screenshotting, particularly ticket theft or unauthorized ticket resale. However, even with the rotating barcodes of the tickets, the attendees still have to go through the insecure process of getting the barcodes of the tickets checked for the event, which is still prone to copying. Therefore, there is an exigency for a secure and user-friendly system to check-in to live events that would simplify the process for attendees and improve their overall experience.

### SUMMARY

In one embodiment, the present disclosure provides one or more techniques that aims to eliminate the drawbacks of the traditional check-in process by introducing a new system to provide a secure the check-in process and to ensure that the attendees easily check-in to the event by scanning the tickets at a gate entrance of the venue.

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

Certain embodiments of the present disclosure described herein relate to systems and methods that enhance and efficiently implement a secure check-in process for events. One embodiment of the present disclosure relates to an event management system including an access management server and a scanner. The access management server receives over a network a request send using a system application of a user device for an access right for an event. A notification to scan the access right provide to the user device. The access right is an entry token associated with access right for an entry to the event. The entry token has data encoded in a live stream. The system application of the user device is enabled to scan the live stream for authorization at a venue entrance of the event. The data encoded in the live stream scanned using the system application of the user device is decoded. The access right for the request is authorized based on information decoded from the live stream for the entry to the event. Other embodiments of this aspect include corresponding computer systems, apparatus, and computer programs recorded on one or more computer storage devices, each configured to perform the actions of the methods.

In one exemplary embodiment, the live or pre-recorded stream includes a video or an audio, and the video or the audio is encoded with real-time user information and kiosk location using video steganography or audio steganography, respectively. Other embodiments of this aspect include corresponding computer systems, apparatus, and computer programs recorded on one or more computer storage devices, each configured to perform the actions of the methods.

Furthermore, the event management system further includes a scanner located adjacent to the venue entrance and the scanner is coupled to the access management server. The scanner is configured to scan the live stream provided by the user device. The live stream is provided to the user device by the access management server. Other embodiments of this aspect include corresponding computer systems, apparatus, and computer programs recorded on one or more computer storage devices, each configured to perform the actions of the methods.

Certain aspects and features of the present disclosure relate to one or more frames of the live stream are encoded with a portion of data at an instant of time, and a plurality of frames of the live stream are encoded with the data. The plurality of frames are decoded to extract the data. The live stream is a live video or a real-time audio, but could be pre-recorded in other embodiments. The access management server is further configured to correlate the data decoded from the plurality of frames of the live stream with the data from a number of frames of a video or an audio received by the access management server at the instant of time and authorize the access right for the user based on the correlation for the entry to the event. Other embodiments of this aspect include corresponding computer systems, apparatus, and computer programs recorded on one or more computer storage devices, each configured to perform the actions of the methods.

Certain aspects and features of the present disclosure relate to the entry token includes user information and an authorization for the entry to the event from the venue entrance. The user information includes at least one of user location, user position, user preferences, or network connection, and the live stream is embedded with advertisements with the data, and the advertisements are based on the user information. Other embodiments of this aspect include corresponding computer systems, apparatus, and computer programs recorded on one or more computer storage devices, each configured to perform the actions of the methods.

One general aspect includes recommendations to the user are provided on the user device based on the user information, and the recommendations include stores, coupons, outlets, and discounts on purchases from the stores located at the user location in the event. Other embodiments of this aspect include corresponding computer systems, apparatus, and computer programs recorded on one or more computer storage devices, each configured to perform the actions of the methods.

In various embodiments, the entry token is encoded using an ultrasonic sound. The user device is enabled to transmit the ultrasonic sound associated with the entry token for scanning and authorization at the venue entrance. A scanner is configured to scan the ultrasonic sound provided by the user device. The entry token encoded using the ultrasonic sound is decoded, and the access right is authorized for the user based on the decoded entry token for the entry to the event. Other embodiments of this aspect include corresponding computer systems, apparatus, and computer programs recorded on one or more computer storage devices, each configured to perform the actions of the methods.

Certain aspects and features of the present disclosure relate to a method for providing access rights to users based on live streams encoded with information for access to events. In one step, a request send using a system application of a user device for an access right for an event is received over a network by an access management server. A notification to scan the access right is provided by the access management server to the user device. The access right is an entry token associated with access right for an entry to the event. The entry token has data encoded in a live stream. The system application of the user device is enabled by the access management server to scan the live stream for authorization at a venue entrance of the event. the data encoded in the live stream scanned using the system application of the user device is decoded by the access management server. The access right for the request is authorized by the access management server based on information decoded from the live stream for the entry to the event. Other embodiments of this aspect include corresponding computer systems, apparatus, and computer programs recorded on one or more computer storage devices, each configured to perform the actions of the methods.

Certain aspects and features of the present disclosure relate to a non-transitory computer-readable medium containing instructions that, when executed by a processor, cause the processor to perform a method for providing access rights to users based on live streams encoded with information for access to events. A request send using a system application of a user device for an access right for an event is received over a network by an access management server. A notification to scan the access right is provided by the access management server to the user device. The access right is an entry token associated with access right for an entry to the event. The entry token has data encoded in a live stream. The system application of the user device is enabled by the access management server to scan the live stream for authorization at a venue entrance of the event. the data encoded in the live stream scanned using the system application of the user device is decoded by the access management server. The access right for the request is authorized by the access management server based on information decoded from the live stream for the entry to the event. Other embodiments of this aspect include corresponding computer systems, apparatus, and computer programs recorded on one or more computer storage devices, each configured to perform the actions of the methods.

### BRIEF DESCRIPTION OF THE DRAWINGS

The present disclosure is described in conjunction with the appended figures:

FIG. 1 illustrates a block diagram of an event management system;

FIG. 2 illustrates a block diagram of a user device and application interface;

FIG. 3 illustrates a block diagram of a venue management device;

FIG. 4 illustrates a block diagram of an end-user device;

FIG. 5 illustrates a block diagram of a transcoding service;

FIG. 6 illustrates a block diagram of a content insertion engine;

FIG. 7 illustrates a block diagram of an access management server;

FIG. 8 illustrates a ticketing application running on an end-user device for purchasing tickets;

FIG. 9 illustrates a ticketing application for providing instructions to users for authentication;

FIG. 10 illustrates an example embodiment of the ticketing application for selecting a live event and selecting nearby stores;

FIG. 11 illustrates an example embodiment of the ticketing application for recommending content by playing an ad alongside the video;

FIG. 12 illustrates an example embodiment of a ticketing application for booking tickets and joining an event;

FIG. 13 illustrates an example embodiment of the ticketing application and smart queue;

FIG. 14 illustrates a user device that provides an overview of a ticket booking and check-in process;

FIG. 15 illustrates a flowchart describing a process for authorizing access to a user for entering a venue of an event;

FIG. 16 illustrates a flowchart of a process for encoding frames of a video to generate encoded data;

FIG. 17 illustrates a flowchart of a process for encoding and decoding data of frames of a video;

FIG. 18 illustrates a flowchart of a process for extracting user information from a video;

FIG. 19 illustrates a flowchart of a process for recommending activities to a user inside a venue; and

FIG. 20 illustrates a flowchart of a process for using ultrasonic sounds as an entry token to authorize the user.

In the appended figures, similar components and/or features may have the same reference label. Where the same reference label is used in the specification, the description applies to any one of the similar components having the same reference label.

### DETAILED DESCRIPTION

The ensuing description provides preferred exemplary embodiment(s) only and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

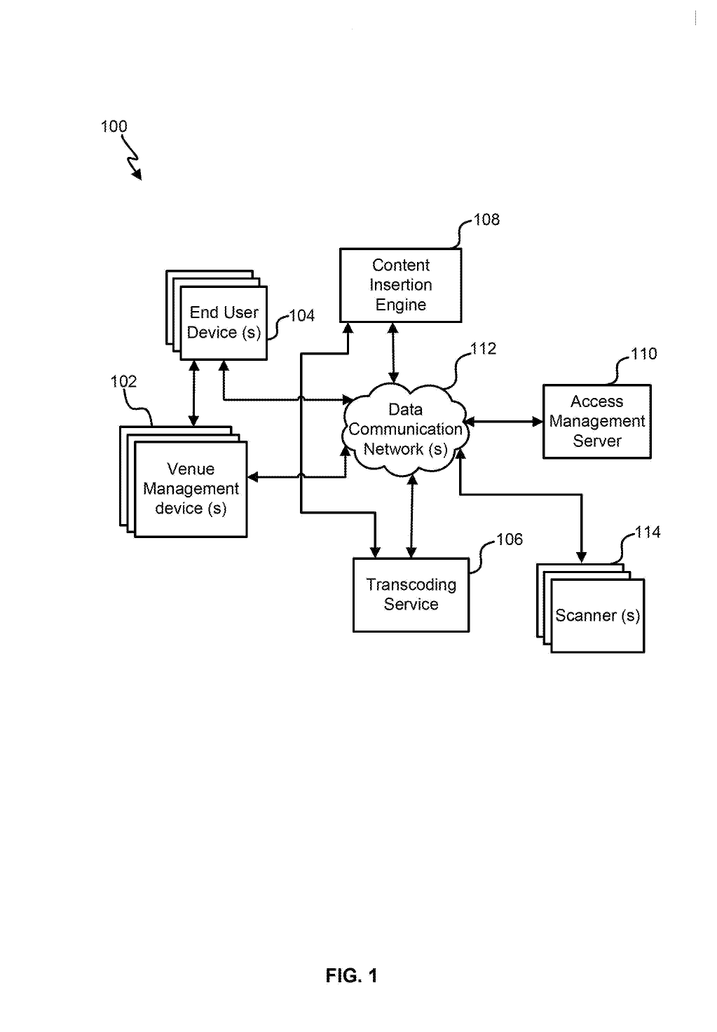

Referring to FIG. 1, illustrates a block diagram of an event management system 100, according to an embodiment of the present disclosure. The event management system 100 includes venue management device(s) 102, end-user device(s) 104, a transcoding service 106, a content insertion engine 108, an access management server(s) 110, a data communication network(s) 112, and scanner(s) 114. Different components of the event management system 100 are connected via the data communication network(s) 112. The data communication network(s) 112 can provide a wireless connection with other components.

In some configurations, the venue management device(s) 102 can be operated by one or more event providers hosting a live event at a venue. The venue management device(s) 102 can generate and/or transmit event-provider communication. The venue management device(s) 102 may be provided with the event related information by an access management server 110 or a third party/external server(s) (not shown). For example, the venue management device(s) 102 can send an event provider communication that indicates Location Y in New York and will host a series of periods (e.g., a series of the play Hamilton on 10 particular nights).

In one embodiment, an individual location associated with a single series of periods is identified from the event provider communication. For example, the received event provider communication indicates an area of Location Y for hosting a single series of Hamilton shows between March 2018 and April 2018.

In another embodiment, the received event provider communication can indicate multiple locations associated with various series of periods. For example, the received event provider communication can indicate Location Y for hosting a series of Hamilton shows between March 2018 and April 2018 and the location Raleigh Arena in Raleigh, N.C., for hosting a series of Hamilton shows between June 2018 and July 2018. As can be seen, a series of periods can correspond to a series of events of a particular performance or show at a particular venue (e.g., location). In such an embodiment, each performance can occur at a particular location at a particular period.

The event providers use servers (not shown) or the access management server 110 and the venue management device(s) 102 to transmit tickets to users and receive purchase amounts for the tickets. The user may receive the ticket and venue information of events from the event provider via the servers (not shown) or the access management server 110. The user can book and purchase the tickets directly from the access management server 110. The access management server 110 provides the ticket to the user on an end-user device 104 of the user after successful payment for the ticket. The user presents the ticket (in the form of a video or audio) to a scanner 114 which identifies the ticket and presents the ticket to the access management server 110 for user verification. The access management server 110 authenticates the ticket provided by the scanner 114. The audio or video could be live or pre-recorded in various embodiments.

In an embodiment, the access management server 110 may request the server (not shown) or third-party servers (not shown) of the event providers to provide details of the ticket to match it with the details of the ticket provided by the scanner 114. The event providers may give the ticket details to the access management server 110 on receiving a request from the access management server 110. The access management server 110 matches the details of the ticket with the details provided by the event providers to authenticate the ticket credentials of the ticket user and authorize access to the user for entering the event.

The end-user device (s) 104 can be used to request the assignment of tickets/tokens from the event providers. The end-user device (s) 104 can be any portable computing device, e.g., smartphones, mobile phones, tablets, and/or other similar devices. Singular user (or fan) attending an event inside the venue can carry the end-user device(s) 104 with them inside the venue. A plurality of activities can be performed with the help of the end-user device(s) 104, for example, but not limited, carrying a ticket in digital form for the event, entering inside the venue using the digital ticket present on an application running on the end-user device(s) 104, making purchases inside the venue using the end-user device(s) 104. For example, while presenting a ticket at an event entrance, the end-user device(s) 104 may communicate with the scanner (s) 114 over a short-range communication channel, such as Bluetooth or Bluetooth Low Energy channel, Near Field Communication (NFC), Wi-Fi, RFID, Zigbee, ANT, etc.

The user via the end-user device (s) 104 bearing a ticket, requests entry into an event venue (e.g., a stadium, a fairground, a concert hall, a lecture hall, etc.). The user is entailed to provide the ticket to the scanner (s) 114 for access to the event. A gatekeeper (e.g., a ticket collector or guard located at the venue entrance) checks the ticket and/or an additional form of identification (by way of example, a driver's license, a passport, a state identity card, a national identify card, a credit card, and/or a smart card) to determine if there is a match (e.g., that the ticket user's name on the ticket matches the name on the additional form of identification).

The scanner(s) 114 may include a bar code scanner, a QR code, a magnetic card reader, and/or a camera that can scan the ticket presented by the user at the gate or entrance of the event venue. The scanner (s) 114 communicates with the access management server 110 to identify the authenticity of the user. The scanner (s) 114 may include a camera to scan the audio or video of the ticket and provide the data of the ticket to the access management server 110 for verification. The video or the audio is encoded using video steganography and/or audio steganography.

In another embodiment, the user scans the video or the audio with a reader of an event management application (also referred as mobile application or system application). The video/audio is displayed at a kiosk near the venue entrance or at the event. The kiosk video/audio is watermarked to contain features such as the kiosk location and the content that is being displayed potentially includes real-time user information such as the user’s gaze and other features. The live watermarking in the video/audio contains the real-time user information. The user can go from one kiosk to another kiosk and the event management application used in conjunction with the kiosk watermarking determines the previous user location and whether the user is doing the desired activities. The kiosk watermarking is used to display a menu associated with the user location, user preferences, and user activities. Other embodiments could used pre-recorded audio and/or video that is watermarked.

The live streaming watermarking embeds unique identifiers in real-time to the video/audio, allowing for immediate tracing of unauthorized restreams and content theft, thereby eliminating ticket theft. The video or the audio is available on the kiosk. The video or the audio can be scanned by the user using the reader. The video or the audio can also be provided to the user on the system application for presenting to the scanner (s) 114 in case the video or the audio scan fails at the kiosk. The access management server(s) 110 include one or more authentication and authorization servers that decode data from an encoded ticket or digital token and based on the decoded data authorize the user to access the event. The access management server 110 provides access rights (access to the event) to the users based on the ticket provided by the user. The user may present the purchased ticket at a gate of the venue entrance of the event. The ticket is purchased from the event providers via the servers (not shown) and/or the access management server 110. The gate may include the scanner 114 or a gate keeper with the scanner 114 to check the ticket. The gate may further include a kiosk. The event may also include a kiosk in proximity to the gate. The kiosk can include a live video or the audio that is scanned by a mobile application or the system application of the user. The video or the audio is watermarked with access information or ticket information. The video or the audio is watermarked with user information such as user location, user preferences, and current user activities. The user information that is watermarked in the video or the audio is used for displaying user specific menu, recommendations, advertisements, and preferences for shopping, events, or content.

Assigning the access right by the access management server 110 can include, for example, associating an identifier of the ticket/token with an identifier of a user, changing a status of the right from available to assigned, facilitating a cease in notifications that the access right is available, generating an access-enabling code to use such that the corresponding access will be permitted and/or generating a notification to be received at the end-user device 104 confirming the assignment and/or including data entailed for corresponding access to be permitted.

The authentication can include, for example, confirming that the access-enabling code has a particular characteristic or format (e.g., generally or one characteristic corresponding to a specific resource or type of access), matches one in an access-enabling code data store (not shown) and/or has not been previously redeemed. A result of the authentication can be locally displayed at an evaluating device, can control a device component (e.g., a physical access control module), and/or can be transmitted to another device, such as the end-user device 104.

In exemplary embodiments, the access rights can be represented in data maintained at the end-user device 104 or at the access management server 110. For example, a database or a data store of the access management server 110 includes a list of identifiers for individual user or the end-user device 104 having an assigned access right for a resource or by associating an identifier for individual user or the end-user device (s) 104 with an identifier of a particular access right.

Further, while the terms “barcodes” (for example, linear barcodes, stacked barcodes, matrix barcodes, rotating barcodes, etc.) and “barcode scanning” may be utilized herein as examples of information and identification encoding and retrieval techniques, other information-bearing techniques and corresponding scanning or reading techniques can be used as well. By way of example, other computer-readable visual indicia (e.g., dots, concentric circles, text codes hidden within images, text readable using optical character recognition systems, etc.), which may in some cases be humanly readable, and other scanners/image capture devices can be used. For example, a scanner/image capture device can be a laser scanner (e.g., including a light source, a lens, and a photo conductor translating optical impulses into electrical ones), a still-frame camera, a video capture device, etc.

The kiosk video/audio is “watermarked” to contain features such as the kiosk location and the content that is being displayed potentially includes real-time user information such as the user’s gaze and other features. The “live watermarking” contains the real-time user information. The system application is used in conjunction with the kiosk watermarking at the kiosk video or the audio to determine the previous user location and the user activities. The kiosk watermarking is used to display a menu based on user information.

The transcoding service 106 includes one or more codecs (coders-decoders) for coding the raw data into a compressed digital format. The tickets or tokens are in the form of a video or the audio. The video may be a live video stream, a stored video, a coding, a video including an advertisement, or a recording. The video is presented by the user at the venue entrance. A live stream from a source such as a camera capturing a video or an audio is sent to a server (not shown) or the access management server 110, where a streaming protocol such as HLS or MPEG-DASH breaks the video feed into smaller segments, which is a few seconds in length. The video content or the audio is then encoded using an encoding standard. The encoding standard used may be H.264, H.265, VP9, and/or AV1. The encoding may be distributed using a Content Delivery Network (CDN).

The content insertion engine 108 uses the encoded video or the audio from the transcoding service 106 to insert data that may be metadata, content (including text, audio, video, or graphics), a barcode, an advertisement, or any other form of data into the video or the audio and link it to the tickets/tokens. The video or the audio is associated with the ticket/token such that by scanning the video or the audio by the scanner 114, the ticket may be authenticated and authorized. The encoded video or the audio may include a barcode or any different type of code for scanning. The encoded video or the audio may further include an advertisement, or some other video or the audio embedded in the video or the audio. The user scans the video or the audio with a reader of the event management application. The video or the audio is displayed at a kiosk. The kiosk video or the audio is “watermarked” to contain features such as the kiosk location and the content that is being displayed potentially includes real-time user information such as the user’s gaze and other features. The “live watermarking” contains the real-time user information. The user can go from one kiosk to another kiosk and the event management application used in conjunction with the kiosk watermarking determines the previous user location and whether the user is doing the desired activities. The kiosk watermarking is used to display a menu.

The content insertion engine 108 provides the video or the audio inserted with the data to the access management server 110 or any external server (not shown). The access management server 110 transmits the video or the audio as the ticket to the user on successful booking and/or payment of the ticket by the user. The user can present the video or the audio for scanning by the scanner 114 while entering the venue of the event.

In another embodiment, the access management server 110 provides a notification to the user to scan the video or the audio provided on a kiosk using the end-user device 104 of the user. The video or the audio displayed on the kiosk is watermarked to contain features such as the kiosk location and the video or the audio content that is being displayed potentially includes real-time information such as the user’s gaze and user features. The live watermarking contains the real-time information. The event management application is used along with the kiosk watermarking at the kiosk video or the audio to determine the user location and the user activities. The kiosk watermarking is used to display a menu to the user on the end-user device 104.

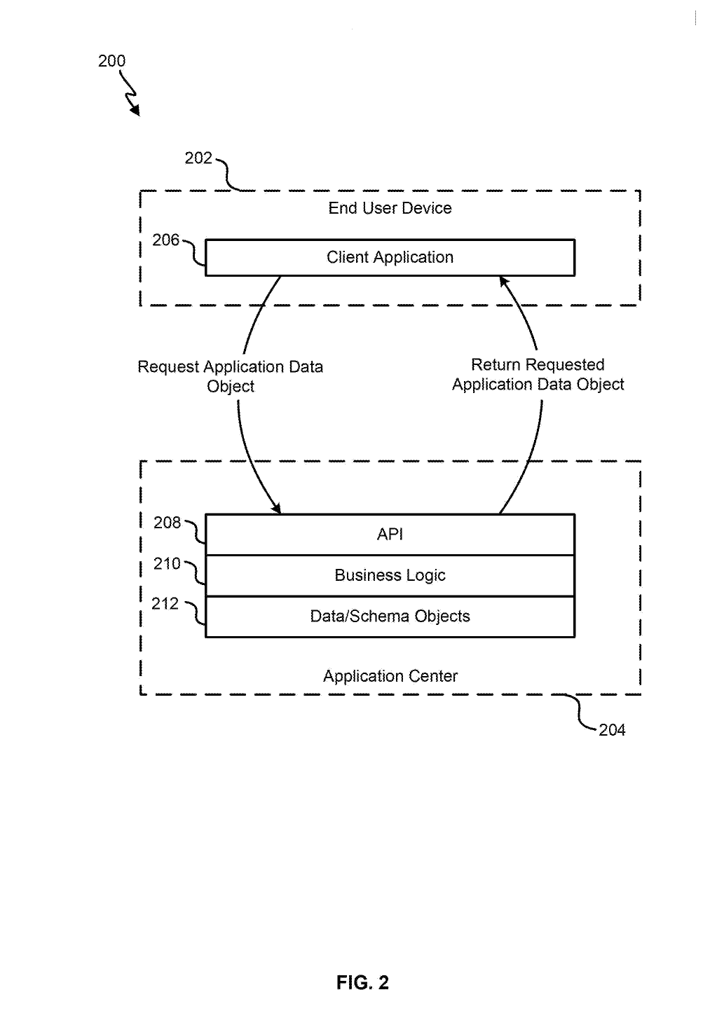

Referring to FIG. 2, illustrates a block diagram 200 of a user device and an application interface embedded with a system and/or apparatus for ticket booking according to an embodiment of the present disclosure. In one embodiment, the block diagram 200 includes an end-user device 202 and an application center 204, which are communicatively coupled with one another. In some embodiments, the end-user device 202 includes a client application 206 such that the client application 206 requests application data objects from the application center 204. Further, the application center 204 includes an application program interface (API) 208, a business logic 210, and data/schema objects 212 for performing various operations on data before transmitting data back to the client application.

In some embodiments, the client application 206 is downloaded from the application center 204 and then installed on the end-user device 202. The client application 206, upon execution on the end-user device 202, provides various features and options for ticket booking.

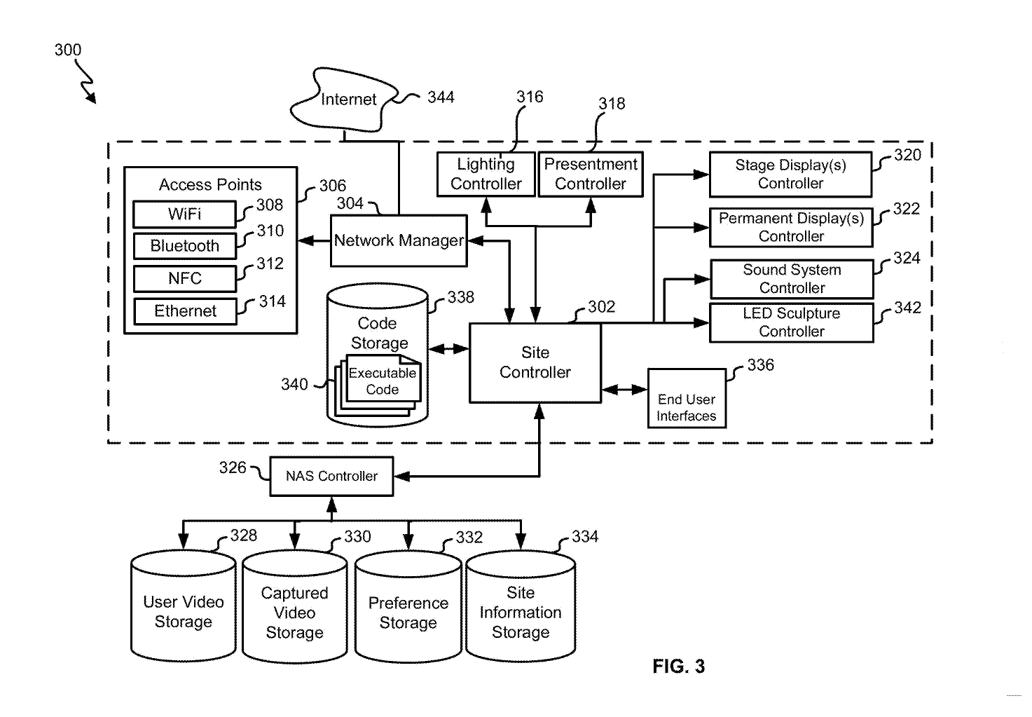

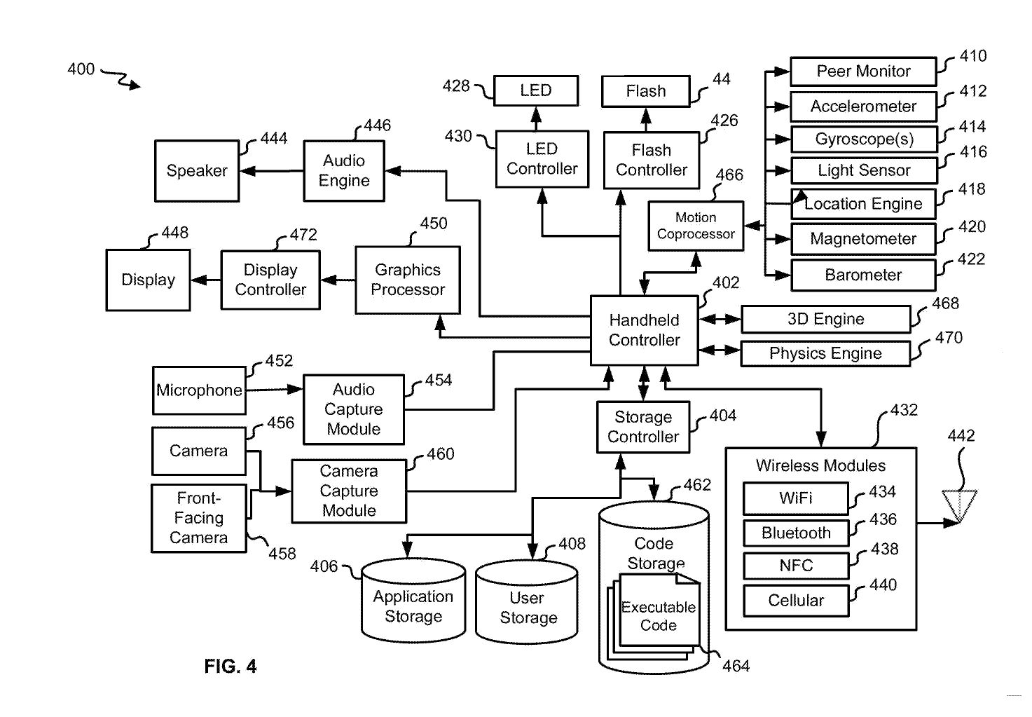

Referring to FIG. 3, illustrates a block diagram of a venue management device 300 according to an embodiment of the present disclosure. Embodiments of a site controller 302 use a network manager 304 to connect via access points 306 (using e.g., a Wi-Fi 308, Bluetooth 310, a Near Field Technology (NFC) 312, an Ethernet 314, and/or other network connections) to other network components, such as site network and the end-user device(s) 104 (not shown herein and described in FIG. 4 as 400). In some embodiments, the site controller 302 controls aspects of an event location. A broad variety of location features can be controlled by different embodiments, including permanent lights (e.g., with a lighting controller 316), stage lights (e.g., with presentment controller 318), stage display screens (e.g., with stage display(s) controller 320), permanent display screens (e.g., with permanent display(s) controller 322), the location sound system (e.g., with a sound system controller 324) and LED sculpture controller 342.

A NAS controller 326 is coupled to a user video storage 328, a captured video storage 330, a preference storage 332, and a site information storage 334. The captured video storage 330 can receive, store, and provide user videos received from end-user device(s). In some embodiments, the site controller 302 triggers the automatic capture of images, audio, and video from the end user device(s), such triggering being synchronized to activities in an event. Images captured by this and similar embodiments can be stored on both the capturing end user device(s) and the user video storage 328. In an embodiment, the site controller 302 can coordinate the transfer of information from the end-user device(s) to the NAS controller 326 (e.g., captured media) with activities taking place during the event. When interacting with the end user device(s), some embodiments of the site controller 302 can provide end-user interfaces 336 to enable different types of interaction. For example, as a part of engagement activities, the site controller 302 can offer quizzes and other content to the devices. Additionally, for location determinations discussed herein, the site controller 302 can supplement determined estimates with voluntarily provided information using the interface of an end-user interface 336, stored in a storage that is not shown. The venue management device 300 can be connected to an internet 344.

In some embodiments, to guide the performance of different activities, the site controller 302 and/or other components can use executable code tangibly stored in code storage 338 comprising executable code 340. In some embodiments, the site information storage 334 can provide information regarding the site, e.g., events, resource maps, attendee information, geographic location of destinations (e.g., concessions, bathrooms, exits, etc.), as well as 3D models of site features and structure.

In one embodiment, all the ticket related transactions are encrypted to save them from any hacking and also use blockchain technology in order to make ticket sales temper proof. In other words, all ticket related transactions are recorded in a distributed ledger, and for every transaction the distributed ledger gets updated with unique values.

Referring to FIG. 4, illustrates a block diagram of an end-user device 400 according to an embodiment of the present disclosure. The end-user device 400 includes a handheld controller 402 that can be sized and shaped so as enable the controller and end-user device 400 in a hand. The handheld controller 402 can include one or more end user-device processors that can be configured to perform actions as described herein. In some instances, such actions can include retrieving and implementing a rule, retrieving an access-enabling code, generating a communication (e.g., including an access-enabling code) to be transmitted to another device (e.g., a nearby client-associated device, a remote device, a central server, a server, etc.), processing a received communication (e.g., to act in accordance with instruction in the communication, to generate a presentation based on data in the communication, or to generate a response communication that includes data requested in the received communication) and so on. In one embodiment, to guide the performance of different activities, the end-user device can use executable code tangibly stored in code storage 462 comprising executable code 464.

The handheld controller 402 can communicate with a storage controller 404 to facilitate local storage and/or retrieval of data. It will be appreciated if the handheld controller 402 can further facilitate storage and/or retrieval of data at a remote source via generation of communications including the data (e.g., with a storage instruction) and/or requesting particular data.

The storage controller 404 can be configured to write and/or read data from one or more data stores, such as an application storage 406 and/or a user storage 408. One or more data stores can include, for example, Random Access Memory (RAM), Dynamic Random Access Memory (DRAM), Read-Only Memory (ROM), flash-ROM, cache, storage chip, and/or removable memory. The application storage 406 can include various types of application data for singular of one or more applications loaded (e.g., downloaded, or pre-installed) onto the end-user device. For example, one or more applications can include applications entailed for scanning the ticket at the entrance of the venue or scanning the video at the kiosk, the application running non-custodial wallets, and applications for other venue-related purchases. Further, application data can include, for example, application code, settings, profile data, databases, session data, history, cookies, and/or cache data. The user storage 408 can include, for example, files, documents, images, videos, voice recordings, and/or audio. It will be appreciated if the end-user device 400 can also include other types of storage and/or stored data, such as code, files, and data for an operating system configured for execution on end-user device 400.

The handheld controller 402 can also receive and process (e.g., in accordance with code or instructions generated in correspondence to a particular application) data from one or more sensors and/or detection engines. One or more sensors and/or detection engines can be configured to, for example, detect the presence, intensity, and/or the identity of (for example) another device (e.g., a nearby device or device-detectable over a particular type of networks, such as a Bluetooth, Bluetooth Low-Energy or Near-Field Communication network); an environmental, external stimulus (e.g., temperature, water, light, motion or humidity); an internal stimulus (e.g., temperature); a device performance (e.g., processor or memory usage); and/or a network connection (e.g., to indicate whether a particular type of connection is available, network strength and/or network reliability). The sensors and detection engines include a peer monitor 410, an accelerometer 412, a gyroscope 414, a light sensor 416, a location engine 418, a magnetometer 420, and a barometer 422. Singular sensor and/or detection engine can be configured to collect a measurement or decide, for example, at routine intervals or times and/or upon receiving a corresponding request (e.g., from a processor executing an application code).

The peer monitor 410 can monitor communications, networks, radio signals, short-range signals, etc., which can be received by a receiver of an end-user device 400. The peer monitor 410 can, for example, detect short-range communication from another device and/or use a network multicast or broadcast to request identification of nearby devices. Upon or while detecting another device, the peer monitor 410 can determine an identifier, device type, associated user, network capabilities, operating system, and/or authorization associated with the device. The peer monitor 410 can maintain and update a data structure to store a location, identifier, and/or characteristic of each of one or more nearby end-user devices 400.

The accelerometer 412 can be configured to detect the proper acceleration of end-user device 400. The acceleration can include multiple components associated with various axes and/or a total acceleration. The gyroscope 414 can be configured to detect one or more orientations (e.g., via detection of angular velocity) of end-user device 400. The gyroscope 414 can include, for example, one or more spinning wheels or discs, single- or multi-axis (e.g., three-axis) MEMS-based gyroscopes.

The light sensor 416 can include, for example, a photosensor, such as a photodiode, active-pixel sensor, LED, photoresistor, or other component configured to detect a presence, intensity, and/or type of light. In some instances, one or more sensors and detection engines can include a motion detector, which can be configured to detect motion. Such motion detection can include processing data from one or more light sensors (e.g., performing a temporal and/or differential analysis).

The location engine 418 can be configured to detect (e.g., estimate) the location of end-user device 400. For example, the location engine 418 can be configured to process signals (e.g., a wireless signal, GPS satellite signal, cell-tower signal, iBeacon, or base-station signal) received at one or more receivers (e.g., a wireless-signal receiver and/or GPS receiver) from a source (e.g., a GPS satellite, cellular tower or base station, or WiFi access point) at a defined or identifiable location. In some instances, the location engine 418 can process signals from multiple sources and can estimate the location of end-user device 400 using a triangulation technique. In some instances, the location engine 418 can process a single signal and estimate its location as being the same as the location of the source of the signal.

The end-user device 400 can include a flash 44 and a flash controller 426. The flash 44 can include a light source, such as (for example), an LED, electronic flash, or high-speed flash. The flash controller 426 can be configured to control when the flash 44 emits light. In some instances, the determination includes identifying an ambient light level (e.g., via data received from the light sensor 416) and determining that the flash 44 is to emit light in response to a picture- or movie-initiating input when the light level is below a defined threshold (e.g. when a setting is in an auto-flash mode). In some additional or alternative instances, the determination includes determining that the flash controller 426 is, or is not, to emit light in accordance with a flash on/offsetting. When it is determined that the flash controller 426 is to emit light, the flash controller 426 can be configured to control the timing of the light to coincide, for example, with a time (or right before) at which a picture or video is taken.

The end-user device 400 can also include an LED 428 and an LED controller 430. The LED controller 430 can be configured to control when the LED 428 emits light. The light emission can be indicative of an event, such as whether a message has been received, a request has been processed, an initial access time has passed, etc.

The flash controller 426 can control whether the flash controller 426 emits light by controlling a circuit to complete a circuit between a power source and the flash controller 426 when the flash 44 is to emit light. In some instances, the flash controller 426 is wired to a shutter mechanism to synchronize light emission and collection of image or video data.

The end-user device 400 can be configured to transmit and/or receive signals from other devices or systems (e.g., over one or more networks, such as network(s)). These signals can include wireless signals, and accordingly, the end-user device 400 can include one or more wireless modules 432 configured to appropriately facilitate the transmission or receipt of wireless signals of a particular type. The wireless modules 432 can include a Wi-Fi module 434, a Bluetooth module 436, anear-field communication (NFC) module shown as NFC 438, and/or a cellular module 440. Each module can, for example, generate a signal (e.g., which can include transforming a signal generated by another component of the end-user device 400 to conform to a particular protocol and/or to process a signal (e.g., which can include transforming a signal received from another device to conform with a protocol used by another component of end-user device 400).

The Wi-Fi module 434 can be configured to generate and/or process radio signals with a frequency between 2.4 gigahertz and 5 gigahertz. The Wi-Fi module 434 can include a wireless network interface card that includes circuitry to facilitate communicating using a particular standard (e.g., physical and/or link-layer standard). The Bluetooth module 436 can be configured to generate and/or process radio signals with a frequency between 2.4 gigahertz and 2.485 gigahertz. In some instances, the Bluetooth module 436 can be configured to generate and/or process Bluetooth low-energy (BLE or BTLE) signals with a frequency between 2.4 gigahertz and 2.485 gigahertz. The NFC 438 can be configured to generate and/or process radio signals with a frequency of 13.56 megahertz. The NFC 438 can include an inductor and/or can interact with one or more loop antennas. The cellular module 440 can be configured to generate and/or process cellular signals at ultra-high frequencies (e.g., between 698 and 2690 megahertz). For example, the cellular module 440 can be configured to generate uplink signals and/or to process received downlink signals.

The signals generated by the wireless modules 432 can be transmitted to one or more other devices (or broadcast) by one or more antennas 442. The signals processed by the wireless module 432 can include those received by the one or more antennas 442. The one or more antennas 442 can include, for example, a monopole antenna, helical antenna, antenna, Planar Inverted-F Antenna (PIFA), modified PIFA, and/or one or more loop antennae.

The end-user device 400 can include various input and output components. An output component can be configured to present output. For example, speaker 444 can be configured to present an audio output by converting an electrical signal into an audio signal. An audio engine 446 can affect particular audio characteristics, such as volume, event-to-audio-signal mapping, and/or whether an audio signal is to be avoided due to a silencing mode (e.g., a vibrate or do-not-disturb mode set at the device).

Further, a display 448 is provided with a display controller 472 and can be configured to present a visual output by converting an electrical signal into a light signal. The display 448 can include multiple pixels, each of which can be individually controllable, such that the intensity and/or color of each pixel can be independently controlled. The display 448 can include, for example, an LED- or LCD-based display.

A graphics processor 450 can determine a mapping of electronic image data to pixel variables on a screen of the end-user device 400. It can further adjust lighting, texture, and color characteristics in accordance with, for example, user settings.

In some instances, the display 448 is a touchscreen display (e.g., a resistive or capacitive touchscreen) and is thus both an input and an output component. The graphics processor 450 can be configured to detect whether, where and/or how (e.g., a force of) the user touched display 448. The determination can be made based on an analysis of capacitive or resistive data.

An input component can be configured to receive input from a user that can be translated into data. For example, end-user device 400 can include a microphone 452 that can capture audio data and transform the audio signals into electrical signals. An audio capture module 454 can determine, for example, when an audio signal is to be collected and/or any filter, equalization, noise gate, compression, and/or clipper that is to be applied to the signal.

The end-user device 400 can further include one or more cameras 456, and 458, each of which can be configured to capture visual data (e.g., at a given time or across an extended period) and convert the visual data into electrical data (e.g., electronic image or video data). In some instances, end-user device 400 includes multiple cameras, at least two of which are directed in different and/or substantially opposite directions. For example, end-user device 400 can include a rear-facing camera 456 and a front-facing camera 458.

A camera capture module 460 can control, for example, when a visual stimulus is to be collected (e.g., by controlling a shutter), a duration for which a visual stimulus is to be collected (e.g., a time that a shutter is to remain open for a picture taking, which can depend on a setting or ambient light levels; and/or a time that a shutter is to remain open for a video taking, which can depend on inputs), a zoom, a focus setting, and so on. When end-user device 400 includes multiple cameras, the camera capture module 460 can further determine which camera(s) is to collect image data (e.g., based on a setting). In some embodiments, components are included that assist with the processing and utilization of sensor data. Motion coprocessor 466, 3D engine 468, and physics engine 470 can all process sensor data, and also perform tasks of graphics rendering related to the graphics processor 450.

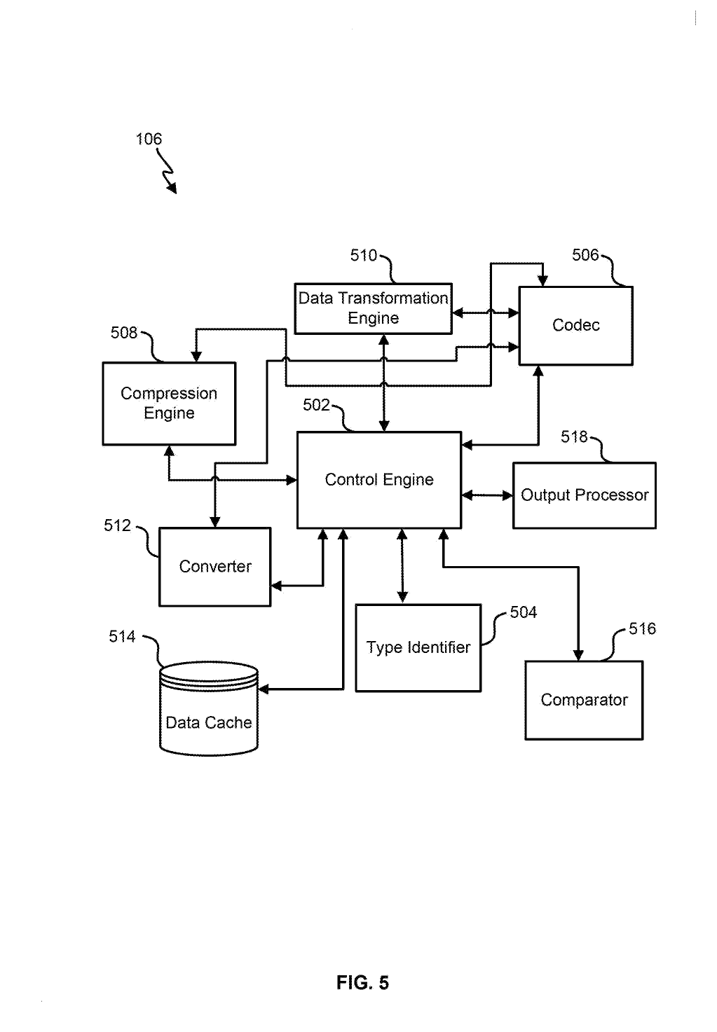

Referring to FIG. 5, illustrates a block diagram of the transcoding service 106 according to an embodiment of the present disclosure. The transcoding service 106 encodes, compresses, and transforms a video stream or audio stream provided by the event providers to the access management server 110. The transcoding service 106 includes a control engine 502, a type identifier 504, a codec 506, a compression engine 508, a data transformation engine 510, a converter 512, a data cache 514, a comparator 516, and an output processor 518.

The control engine 502 manages the functions of the transcoding service 106 in transforming the video stream or the audio stream by encoding data into the video stream or the audio stream. The transcoding is a digital-to-digital conversion of one type of encoded video or audio to another, often of smaller file size. For example, a raw video from a digital camera can be converted to H.264 format for easier display. In another embodiment, the control engine 502 may receive an already encoded video or the audio from the access management server 110, decode it into an intermediate uncompressed format, and then re-encode the video or the audio into another format. Along with the video stream or the audio stream, the access management server 110 also provides suitable formats in which the video stream or the audio stream has to be converted after encoding.

The format for conversion is provided to the codec 506 by the control engine 502. The event providers send the stipulations of parameters, including desired file format, device compatibility, compression rates, bitrates, encoding standard to be used, or other details to the control engine 502 via the access management server 110. The control engine 502 further provides these parameters and their desired values to the type identifier 504, the codec 506, the compression engine 508, the data transformation engine 510, the converter 512, and the comparator 516. The stipulations and other details associated with the video stream the or audio stream may be stored in the data cache 514 and retrieved when exigent.

The control engine 502 provides the video or audio stream obtained from the access management server 110 to the type identifier 504. The type identifier 504 determines a type of file format of the video stream for example, MP4, AVI, MK4 or other formats. The type of file format of the or audio stream for example, MP3, WAV, FLAC, AAC, or other formats. The identification is provided to the codec 506 for further processing.

The codec 506 encodes or decodes the video or the audio stream obtained from the access management server 110 using video steganography and/or audio steganography. The codec 506 includes a number of encoders or decoders (for example, H.264 (AVC) and H.265 (HEVC), VP9, and Alliance for Open Media Video (AV1)) to perform encoding or decoding of the video stream, respectively. Similarly, the codec 506 includes a number of encoders or decoders to perform encoding or decoding of the audio stream. The video stream or the or audio stream may be in a raw form or a format that needs to be encoded into another format. The format of the video stream is obtained from the type identifier 504 and the format for conversion is obtained from the control engine 502. One or more frames of the video stream or the audio stream is encoded. In another embodiment, the data is encoded in singular frame of the video stream using video steganography or audio steganography. This is also referred as a digital fountain where the frames include data. The video steganography or audio steganography is leveraged with the digital fountain to encode “error correcting” data. The audio steganography with the digital fountain is used to encode the data in the audio. If one or more portions of the data are missing, the one or more portions of the data can be retrieved around in the stream later in time. Further, Sphere™ can use directed audio to give different audio experiences to different sections of the venue. After encoding the video stream or the audio stream, the encoded video or audio is provided to the compression engine 508 for further processing. The codec 506 communicates with the converter 512 to convert the video or audio from one format to another.

The compression engine 508 uses the encoded video or audio and performs compression or decompression as per requirement of the event providers. Commonly used video formats are Moving Picture Experts Group (MPEG), MPEG-4 Part 14 (MP4), MOV, Audio Video Interleave (AVI), Windows Media Video (WMV), Flash Video (FLV), WEBM, Advanced Video Coding High Definition (AVCHD), Matroska Video (MKV).

The compression engine 508 ensures compatibility and widespread adoption of the video or audio. A number of factors like bitrate, resolution, and file size, has to be considered while performing compression. The video or audio compression affects the bit rate of the video or audio file by reducing the amount of data per second in the video or audio, respectively. A balance is exigent between the size of the video or audio and the video or audio quality. The compression engine 508 considers these factors during compression. The compressed video or audio is provided to the data transformation engine 510 for processing.

The data transformation engine 510 enhances the video quality by removing redundant frames, adjusting the video’s brightness, contrast, saturation, resolution, trimming unnecessary parts of the video, color enhancement and restoration, and/or removing background noise. Similarly, audio quality is enhanced by adjusting the sound, frequency and/or tone. The transformed video or audio is provided to the converter 512 for processing.

The converter 512 identifies whether a conversion of file format, resolution, or size is entailed and performs the conversion based on the stipulations of the event providers or any update in the parameters by the event providers. The update may be communicated with the converter 512 via the control engine 502 from the access management server 110. The converter 512 updates the video or audio based on the stipulations and/or the updated requirements and provides the updated video to the comparator 516. If no new updates are available from the access management server 110 or the codec 506 has already performed the conversion and no further conversion is entailed, then the converter 512 sends the video or the audio to the comparator 516 without any conversion.

The comparator 516 determines whether the updated video or audio from the converter 512 matches to the stipulations/parameters of the event providers shared by the control engine 502. The comparator 516 matches the file size, bitrate, resolution, and compatibility, among other parameters. The parameters are retrieved from the data cache 514 by the comparator 516 and matched with the video parameters. If changes are required based on the match, the comparator 516 communicates it to the converter 512 or the codec 506 for updating the video. Else, the comparator 516 provides the video to the output processor 518.

The output processor 518 receives the video or the audio from the comparator 516 and provides the video or the audio to the content insertion engine 108 for further processing. The output processor 518 may also store the video or the audio in the data cache 514 and provide the video or the audio to the access management server 110 for verification on retrieval.

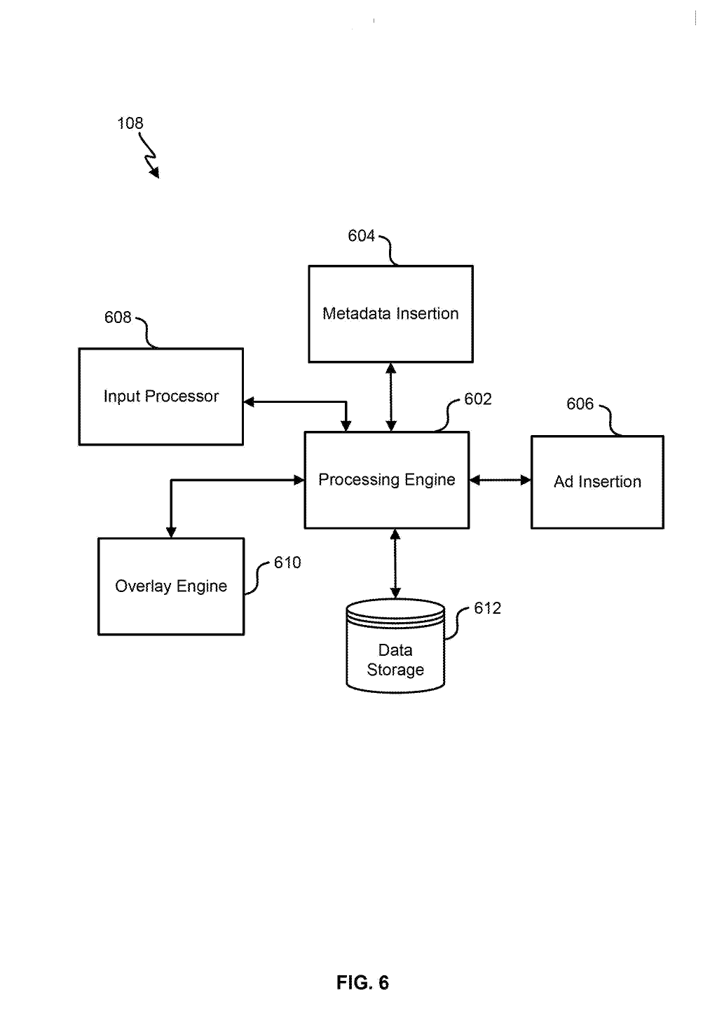

Referring to FIG. 6, illustrates a block diagram of the content insertion engine 108 according to an embodiment of the present disclosure. The content insertion engine 108 uses the video or audio from the transcoding service 106 to insert data into the compressed and encoded video or audio obtained from the transcoding service 106. The content insertion engine 108 is in communication with the event providers via the venue management device(s) 102 and the access management server 110 to receive data for insertion into the video or audio. The content insertion engine 108 includes components such as a processing engine 602, a metadata insertion 604, an advertisement (ad) insertion 606, an input processor 608, an overlay engine 610, and a data storage 612.

The processing engine 602 controls the functions of components of the content insertion engine 108. The processing engine 602 initially receives a ticket in the form of a video or audio as an input from the input processor 608 and analyses the video or the audio to identify one or more frames where data is to be inserted in the video or the audio.

The input processor 608 receives the input ticket in the form of a video or the audio from the transcoding service 106. The transcoding service 106 processes the input video or the audio provided by the event providers from the access management server 110 and/or the venue management device(s) 102 or an external server (not shown). The access to the event is provided by a ticket that is verified using a video or audio. The video may be a live stream, a graphics or in a textual or audio form. The video or audio is provided by the event provider to the input processor 608 via the access management server 110.

The processing engine 602 identifies a type of content to be embedded in the video or the audio for verification. For example, an advertisement, a video, metadata, or some other content overlayed on the video or the audio. The type of content to be embedded is provided by the event provider via the access management server 110. Based on the identification of the type of content to be embedded, the processing engine 602 instructs the ad insertion 606, the metadata insertion 604, and/or the overlay engine 610 to embed the content into the video or the audio. One or more frames of the video or the audio are encoded with the data. In another embodiment, individual frame of the video or the audio is encoded with the data.

In another embodiment, the processing engine 602 may use artificial intelligence or machine learning techniques to identify the content to be embedded in the video or the audio. The processing engine 602 may also embed data in the video or the audio. The content is based on user profiles stored in the data storage 612. The data storage 612 includes the user profiles that include user information including username, past bookings, user preferences, user interests, nearby stores visited by the user, advertisements seen or other data about the user obtained from past bookings by the event providers. The event providers store the user information in the access management server 110 and/or the data storage 612.

The processing engine 602 instructs the metadata insertion 604 to insert metadata into the video or the audio obtained from the transcoding service 106. The metadata may be tags, modifying metadata, custom tags, title, description, author, creation date, or other details related to the video or the audio. The metadata may be pre-stored in the data storage 612 or obtained from the access management server 110. The metadata may be provided by the event providers to the access management server 110 which further provides the metadata for insertion to the processing engine 602 or stored in the data storage 612. The metadata may be obtained by using artificial intelligence or machine learning techniques based on the user profiles from the data storage 612. The metadata insertion 604 embeds the metadata into the video or the audio and provides it to the processing engine 602.

The processing engine 602 instructs the ad insertion 606 to insert an advertisement into the video or the audio. The advertisement may be prestored in the data storage 612 or obtained from the access management server 110. The event providers may provide the ad to the access management server 110 or store in the data storage 612. The advertisement (ad) may be obtained by using artificial intelligence or machine learning techniques based on the user profiles from the data storage 612. The ad insertion 606 embeds the ad into the video or the audio and provides it to the processing engine 602.

The processing engine 602 instructs the overlay engine 610 to insert data into the video or the audio. The data may be prestored in the data storage 612 by the event providers or obtained from the access management server 110. The data may also be obtained by using artificial intelligence or machine learning techniques based on the user profiles from the data storage 612. The overlay engine 610 embeds the data into the video or the audio and provides it to the processing engine 602.

The processing engine 602 forwards the video or the audio with overlayed data obtained from the overlay engine 610, the video or the audio with the embedded metadata obtained from the metadata insertion 604, the video or the audio with the embedded ad obtained from the ad insertion 606 and/or other embedded data in the video or the audio to the access management server 110. The access management server 110 further provides the video or the audio to the user on booking confirmation such that the video or the audio can be presented to the scanner 114 at the time of entering the event. In another embodiment, the access management server 110 provides the video or the audio on a kiosk enabling the user to scan the video or the audio on the kiosk using the mobile/system application of the end-user device 104.

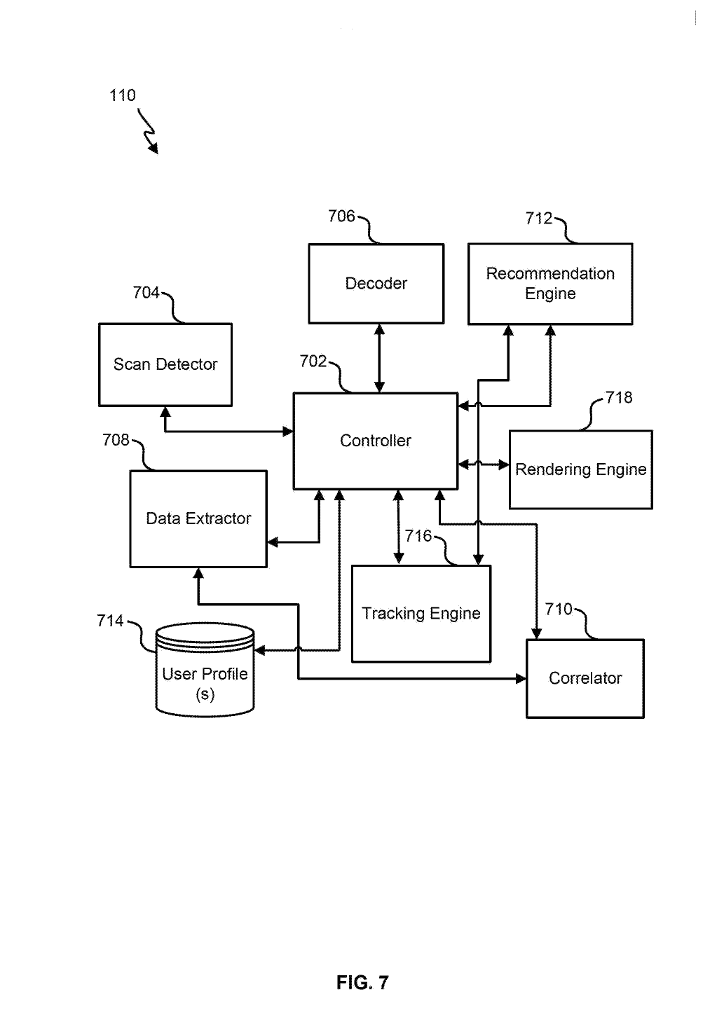

Referring to FIG. 7, illustrates a block diagram of the access management server 110 according to an embodiment of the present disclosure. The access management server 110 receives the encoded video or the encoded audio including the data for verifying the user's access to an event. The encoded video or the audio is received from the content insertion engine 108 and/or the transcoding service 106. The access management server 110 includes a controller 702, a scan detector 704, a decoder 706, a data extractor 708, a correlator 710, a recommendation engine 712, a tracking engine 716, user profile(s) 714, and a rendering engine 718.

The controller 702 manages the input from the event providers, the verification of the data decoded from the entry token, and the generation of recommendations provided to the user. The scanned entry token is provided to the controller 702 by the scanner(s) 114 after detecting the entry token or the ticket. The recommendations are provided to the user on the end-user device 104 of the user.

In an embodiment, the scan detector 704 receives a signal from the scanner 114 when the scanner 114 detects a video or the audio presented by the user at the scanner 114. The scanner 114 is installed at the venue entrance of an event. The scanner 114 transmits the video or the audio to the scan detector 704 using a data communication network 112. The scan detector 704 identifies the video or the audio and sends the video or the audio to the controller 702. The scanner 114 further identifies a code embedded in the audio. The scanner 114 identifies a code embedded in the video such as a barcode or QR code. The controller 702 sends the video or the audio to the decoder 706.

In another embodiment, the video or the audio is displayed on the kiosk to the user. The user scans with a reader of the mobile application, the video or the audio displayed at the kiosk. The kiosk video or the audio is watermarked to contain features such as the kiosk location, user information and user specific content.

The decoder 706 analyses the video or the audio received from the controller 702 to decode the data in the video or the audio. The decoder 706 uses decompressors and converters to transform the encoded video or the audio back to the original raw video or the audio. The decoder 706 uncompresses the encoded video or the audio and converts the encoded video stream or the audio stream into a format suitable for display on screens or broadcast systems. The decoded data is provided to the data extractor 708.

The data extractor 708 processes data including metadata, ad, content, or other data embedded in the video or the audio. The data is extracted from the video or the audio, and the data is essential in the authentication of the user as being legit. The data extractor 708 includes parsers and machine learning algorithms to extract the data from the content of the video or the audio. The extracted data may include user details, payment information, booking details and user information. The extracted data is provided to the correlator 710.

The controller 702 verifies the data extracted from the video or the audio with the data provided by the event provider for the video or the audio. When a match exists, the user payment and booking details are checked with the servers (not shown) of the event providers. Authentication is performed on the end-user device 104 of the user and based on the authentication, the user is authorized access to the event. The user is notified of a result of the authorization on the end-user device 104 using the rendering engine 718. The user may be granted or blocked access to the venue based on the result of the authorization.

The correlator 710 identifies the user from the data of the video or the audio provided by the data extractor 708. The correlator 710 matches the user information including the username extracted from the data of the video or the audio with the usernames and user details stored in the user profiles 714. The user profiles 714 stores the user profiles of users that have booked tickets for the event in the past. If the correlator 710 does not find a match of the username from the data to the usernames in the user profiles stored in the user profiles 714, a new user is identified. The new user has booked the ticket for the first time. The user details are stored in the user profiles 714. If a match exists, details such as user interests, user preferences, payment details, ad viewed, and nearby stores visited are extracted from the user profiles 714 and provided to the recommendation engine 712. The user details for the current bookings are updated in the user profiles 714 for retrieval and matching with the users on booking tickets.

The recommendation engine 712 identifies suggestions or recommendations for the user for example, advertisements, content of interest, and nearby stores with discounts based on the user details obtained from the user profiles 714. The recommendations include stores, coupons, outlets, and discounts on purchases from the stores located at the user location in the event. The recommendations may be generated using machine learning techniques and artificial intelligence. The prestored user details are used in generating suggestions for the user. When the user is new, recommendations are generated with the user information that is available from the data in the video or the audio. The recommendation engine 712 communicates with the tracking engine 716.

The tracking engine 716 identifies user location and user movements as the user enters and moves in the venue. The tracking engine 716 uses various location tracking technologies for example, Global Positioning System (GPS), Wi-Fi Positioning System (WPS), Radio Frequency Identification (RFID), biometrics, or satellite communication to track the current location and position of the user in real-time. The user location is provided to the recommendation engine 712. The recommendation engine 712 may update the suggestion of nearby stores, discounts on food, outlets, stores, coupons, or advertisements to be shown to the user based on the user’s location. The recommendations are provided to the user on a display of the end-user device 104 using the rendering engine 718.

The rendering engine 718 communicates with the end-user device 104 and facilitates display of the recommendations on the end-user device 104. The recommendations may include advertisements shown to the user, discounts, coupons, stores, and/or content of user interest. The user may also be provided with questionnaire to answer or options to select. In another embodiment, the video or the audio provided as the ticket may include the recommendations embedded into the video or the audio as the data.

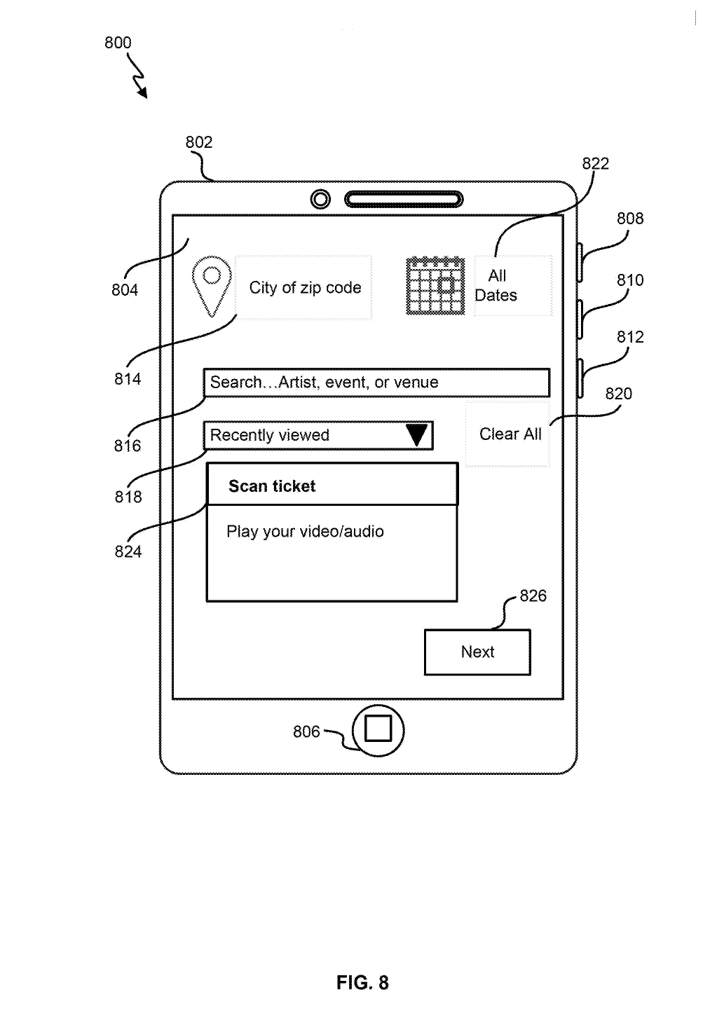

Referring to FIG. 8, illustrates a ticketing application running on the end-user device(s) 104 for purchasing tickets in accordance with an embodiment of the present disclosure. In one exemplary embodiment, FIG. 8 depicts a user device 800 that is used for the ticket booking process and check-in process. A user device 802 includes a user interface 804 that displays multiple soft buttons and options for the user to book tickets, authenticate, and check-in for a live event. A control button 806 is located at the bottom center of the user device 802, which enables the user to access different features of the device. The volume up switch 808 and volume down switch 810 are used to adjust the volume of the device, and a lock screen button 812 is used to lock the device’s screen.

The user interface 804 includes several elements, such as a location information icon 814 which shows the current location of the user. A calendar 822 helps the user to select the date for the event, and a search bar 816 allows the user to search for the desired event. The recently viewed item 818 displays the user’s recent activity, and the list of recently viewed items shows a list of all recently viewed items. For example, audio, videos and advertisements viewed, audio played, search history etc. The clear all soft button 820 allows the user to clear all the recent activities, and a next button 826 is used to move to the next window after providing all the necessary details.

In one exemplary embodiment, the ticketing application represents a user-friendly interface for booking tickets and check-ins for live events. The user can easily navigate through the different options and features of the user device 802 to book tickets and scan tickets at entry. A scan ticket button 824 allows the user to scan the ticket using the mobile application or verify the entry token by scanning a video or an audio on the kiosk. The video or the audio is provided by the event providers after booking the ticket via the access management server 110.

In yet another example, the ticketing application provides real-time updates on the status of the event, such as the availability of tickets and the number of people in the event. Additionally, joining groups provides several advantages, such as discounted ticket prices, priority access to the event, and the opportunity to meet like-minded people.

In yet another example, other possible embodiments and examples may include additional features and options for the user, such as a payment gateway, seat selection, and event reminders. The user device 802 may also include a camera and a microphone for enhanced security and authentication purposes. Furthermore, the ticketing application may provide additional services, such as hotel bookings and transportation services, for the user's convenience.

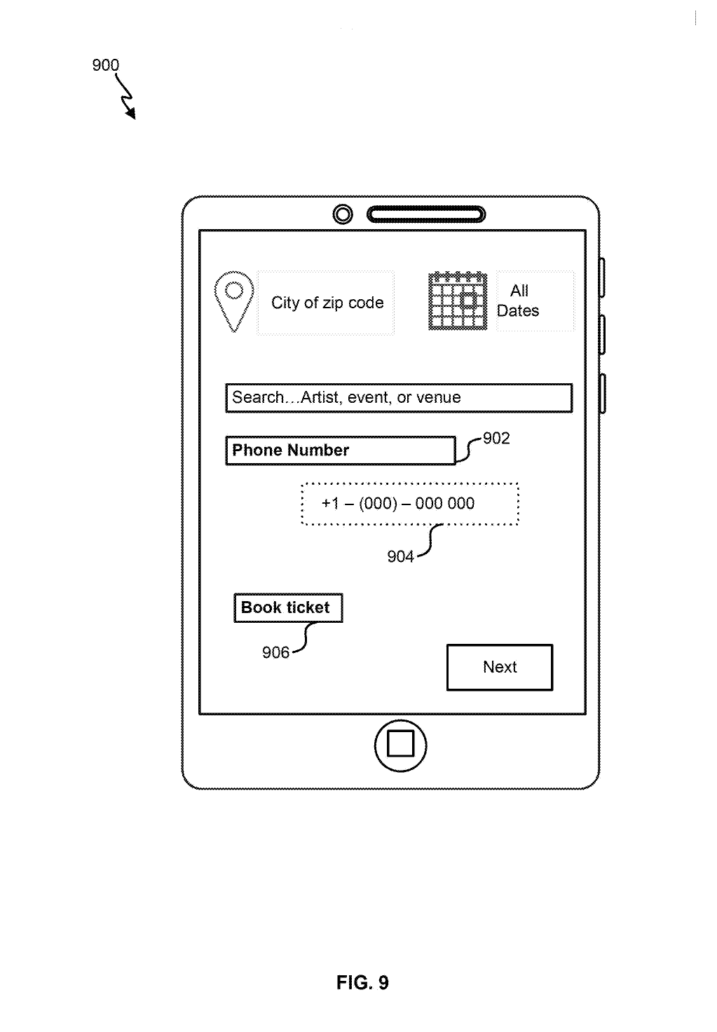

Referring to FIG. 9, illustrates an example embodiment of the ticketing application for providing instructions to users for authentication in accordance with an embodiment of the present disclosure. In one exemplary embodiment, FIG. 9 depicts a representation of a user device 900 that provides a general overview of a ticket booking process and a check-in process. The user interface includes various soft and hard buttons, as described in FIG. 8, and in addition, a pop-up window 902 is displayed on the user interface that shows phone number details. An editable area 904 is also provided where the user can input their phone number to complete the authentication and verification process.

The pop-up window 902 displayed on the user interface shows phone number details. The editable area 904 represents the editable area provided for the user to enter their phone number. Book ticket button 906 allows the user to book the ticket after searching for the event or venue.

In one exemplary embodiment, the system provides enhanced security for the ticket booking process by providing an additional authentication and verification step via the phone number. This helps in preventing fraud and unauthorized access to the ticket booking system. The editable area also makes it easy for the user to enter their phone number, improving the user experience.

In addition, entering the venue by scanning the video or the audio on the kiosk is advantageous as it restricts copying and misuse of the ticket. By scanning the video or the audio, which may be a live stream or a stored video or audio, the user is authorized to enter the venue. The video or the audio is used as a ticket to provide the user with an inimitable video or the audio. The video or the audio may be recorded or streamed in real-time and provided to the user. The scanner 114 is capable of scanning the video or the audio shared on the end-user device 104 or the kiosk and providing the details to the access management server 110 for verification.

Other possible embodiments of this embodiment include additional security measures such as facial recognition or fingerprint scanning or the inclusion of additional user information such as email or social media profiles for enhanced authentication and verification.

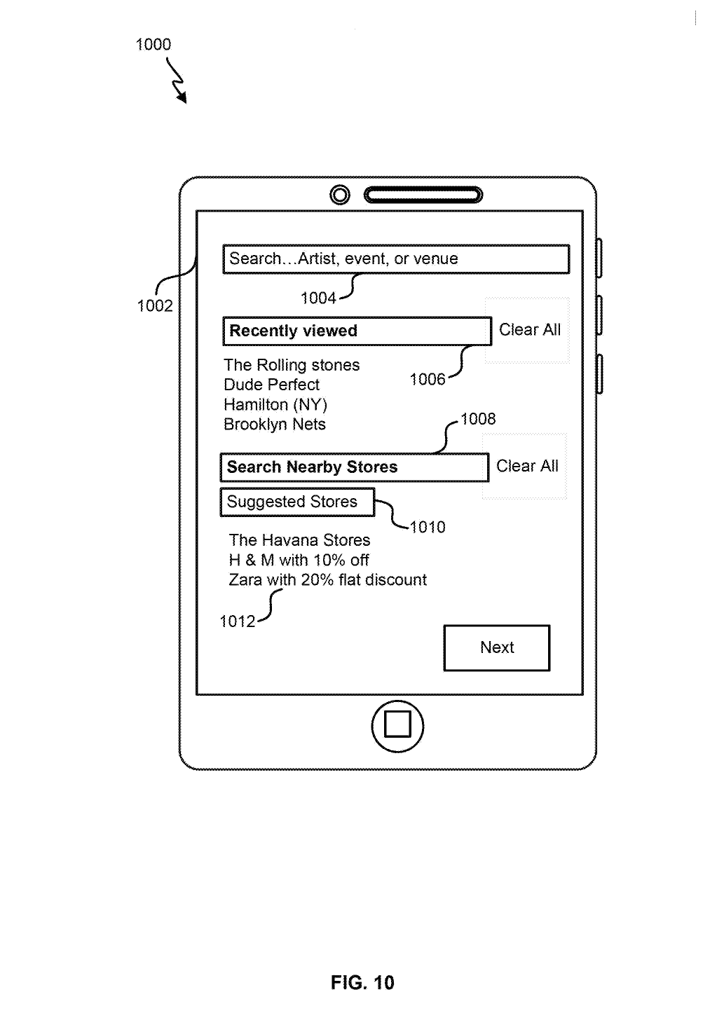

Referring to FIG. 10, illustrates an example embodiment of the ticketing application for selecting a live event and selecting nearby stores in accordance with an embodiment of the present disclosure. In one exemplary embodiment, FIG. 10 depicts a representation of a user device 1000 that provides a general overview of a ticket booking process and a check-in process. A user interface 1002 is embedded within the user device 800, as described in FIG. 8. After the successful completion of authentication, the user interface 1002 provides multiple options for viewing recently viewed items or an option for clearing all recently viewed items. Additionally, the user interface 1002 includes an interface for searching artists, events, or venues 1004, recently viewed items 1006, nearby stores 1008, an interface that provides recommended stores 1010, and a list of the recommended stores with discounts 1012 as a result of search options.

The user device 1000 represents the user device, which could be a smartphone or a tablet computer, used for accessing the ticket booking application. FIG. 10 represents the user interface 1002 embedded within the user device 802. The access management server 110 generates recommendations for display on the user interface 1002.

In one exemplary embodiment, the access management server 110 enhances the user experience by providing additional options for recently viewed items and suggested stores. This helps users quickly and easily find the information they want and make informed decisions about which events and groups to join.

Other possible embodiments of this patent drawing could include additional search options such as filtering by location or event type or the inclusion of additional advertisements based on user preferences or past attendance history.

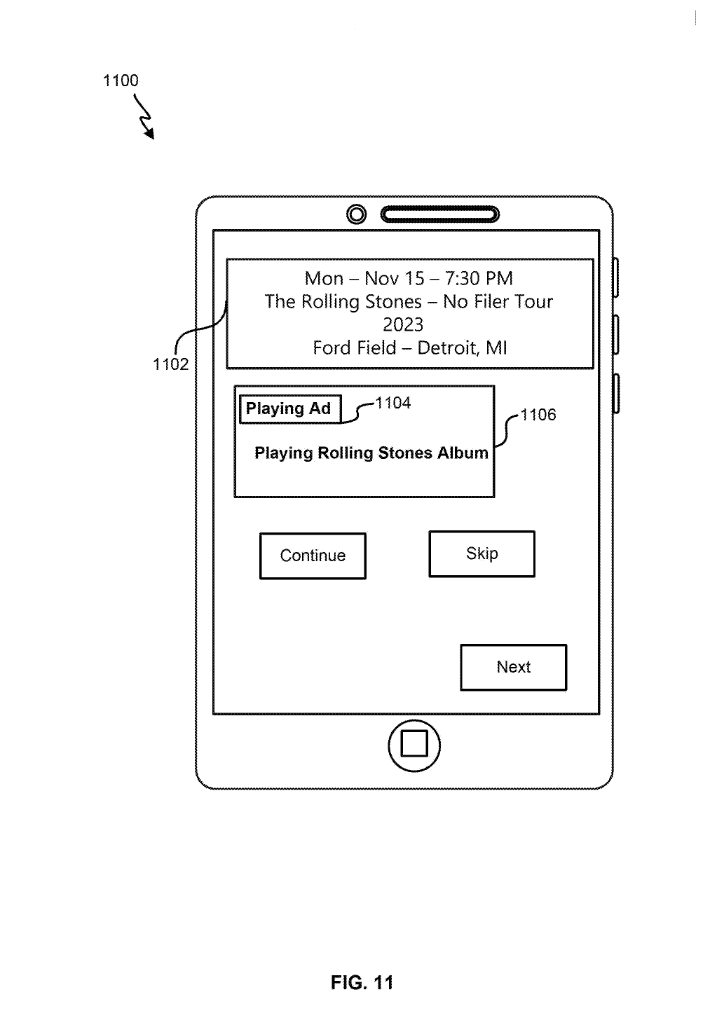

Referring to FIG. 11, illustrates an example embodiment of the ticketing application for recommending content by playing an advertisement (ad) alongside the video or the audio in accordance with an embodiment of the present disclosure. In one exemplary embodiment, FIG. 11 represents a user device 1100 that provides a general overview of the ticket booking and check-in processes. Once the ticket is booked for an event, event details 1102 are displayed on the user interface. A video or an audio (live stream) is provided by the access management server 110 along with an ad in the video or the audio after the successful booking of the ticket. An interface 1106 plays the video or the audio and a section 1104 on the interface 1106 plays the ad. The user interface enables the user to either continue playing the ad or skip the ad and move to the next window.

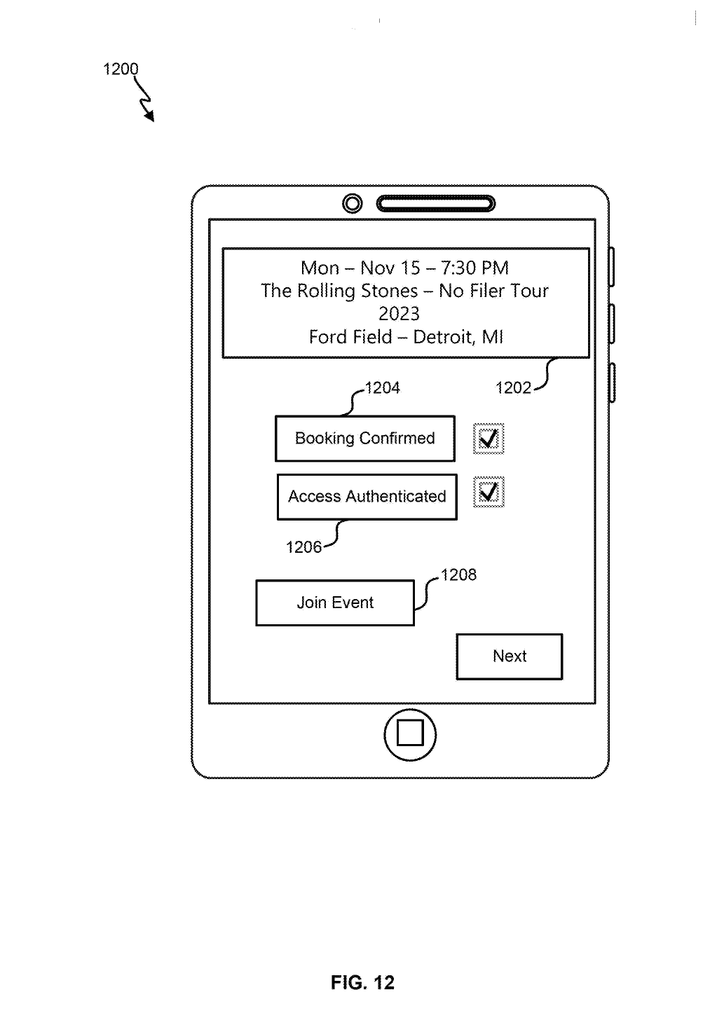

Referring to FIG. 12, illustrates an example embodiment of the ticketing application for booking tickets and joining an event in accordance with an embodiment of the present disclosure. In one exemplary embodiment, FIG. 12 represents a user device 1200 and provides an overview of the ticket booking process and check-in process. The drawing includes several elements, including event details 1202, a booking confirmation 1204, confirmation access 1206, and a join event button 1208.

When the ticket has been successfully booked, the booking confirmation is displayed on the booking confirmation 1204. When the user gets the ticket (video/audio) scanned at the kiosk of the event entrance by the scanner 114, on successful authorization the user gets the access confirmed on the confirmation access 1206 element. The user may join the event by clicking the join event button 1208 as the user enters the event. The user may get recommendations, or the user can search for content or items on the user interface by clicking the next button. The recommendations are displayed as shown in the FIG. 10.

The event details 1202 indicate the specifics of the event being booked, such as the date, time, location, and other relevant information. The booking confirmation 1204 indicates that the user's ticket reservation has been confirmed, and the confirmation access 1206 indicates that the user can successfully join the event associated with the event.

Once the user device 1200 receives both the booking confirmation 1204 and the confirmation access 1206, the join event button 1208 becomes enabled. The user's location is continuously tracked to send updates and recommendations on the mobile application.

In one exemplary embodiment, by requiring confirmation of booking and access before enabling the join event button, the access management server 110 ensures that only authorized users can initiate the check-in process. This helps to prevent fraudulent activity and ensures that users are accounted for during the check-in process.

Other embodiments and examples may include variations in the types of events or groups that can be booked through the event management system 100. For example, the event management system 100 could be used to book tickets for sporting events, concerts, or other types of gatherings. Additionally, the event management system 100 could be used to create groups for other purposes, such as networking events or team-building activities.

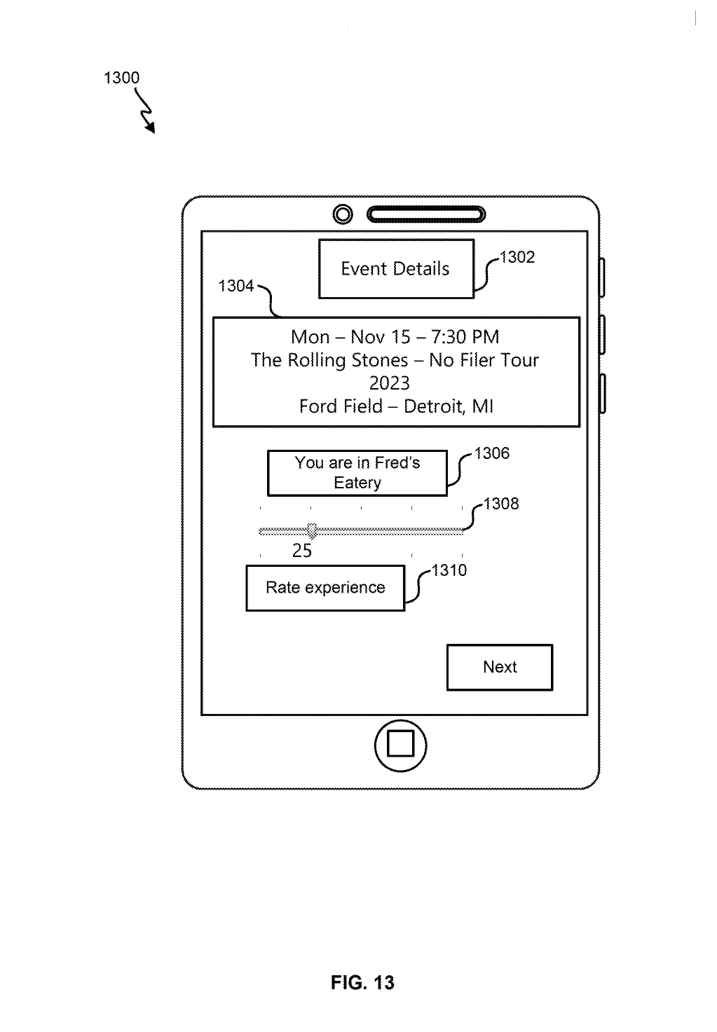

Referring to FIG. 13, illustrates an example embodiment of the ticketing application and smart queue in accordance with an embodiment of the present disclosure. In one exemplary embodiment, FIG. 13 represents the user interface of a mobile application for booking event tickets and check-ins. Moreover, FIG. 13 represents a user device 1300, which provides an overview of the ticket booking and check-in process. The user interface shows various details related to event booking, including event details 1302, which are displayed after booking confirmation, and event details with time and location 1304. A status indicator 1306 indicates the present location of the user in the event. The user can provide ratings for the experience by clicking on rate experience 1310. A visual indicator 1308 allows the user to provide ratings. These ratings and feedback are shared with the access management server 110 for improvements and updating recommendations.

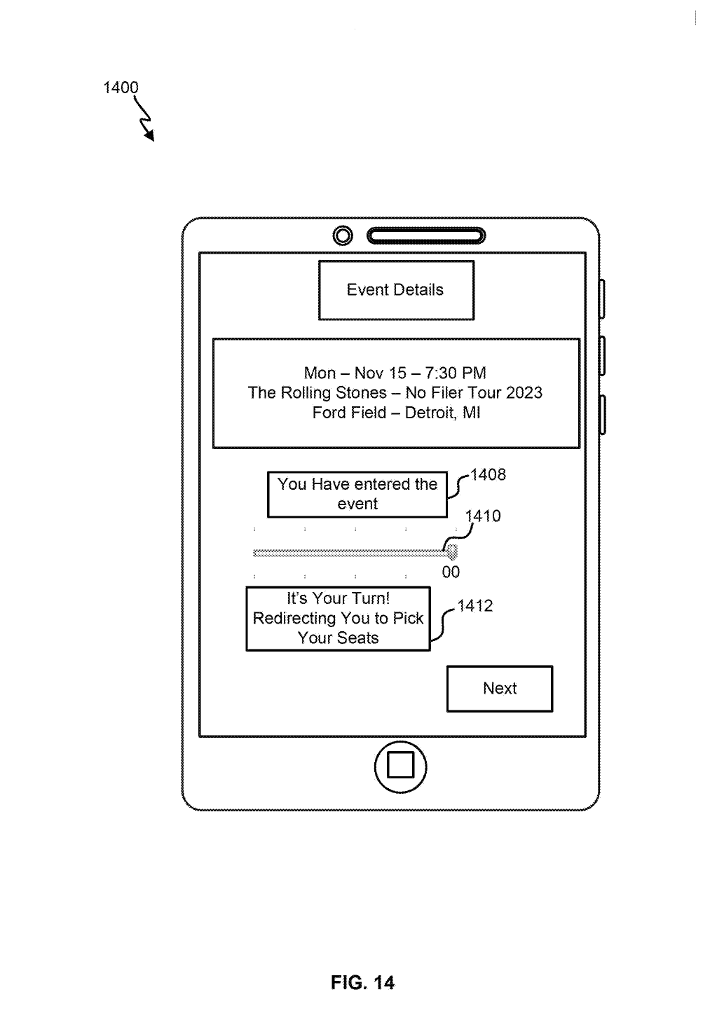

Referring to FIG. 14, illustrates a user device 1400 that provides an overview of the ticket booking and check-in process in accordance with an embodiment of the present disclosure. The drawing includes two main elements, an entry indicator 1408 and a notification button 1412 on the user interface. The entry indicator 1408 shows the updated status of the user’s location in the event venue, indicating whether the user has entered the event. A queue indicator 1410 shows a count of users ahead of the current user. As the users ahead of the current user are served, the queue indicator 1410 will reach zero, indicating that it is the user's turn to pick the seats.

Once the indicator reaches zero, the notification button 1412 on the user interface will change to show that it is the user's turn to pick the seats. Based on the user's input on the notification button 1412, the user interface will be redirected to the available seating arrangement, showing the status of vacant/available seats. This allows the user to easily pick the seats they want.

In one exemplary embodiment, the event management system 100 improves the efficiency of the ticket booking and check-in process. By providing a clear indicator of the user's place in the queue and notifying them when it is their turn to pick the seats, the process is streamlined, reducing the time users spend waiting in line and improving the overall experience.

Other possible embodiments and examples related to this disclosure include using the smart queue indicator and notification button for other types of events, such as concerts or sports games. Additionally, the user interface could include additional features, such as the ability to view the seating chart or purchase additional tickets for friends or family members.

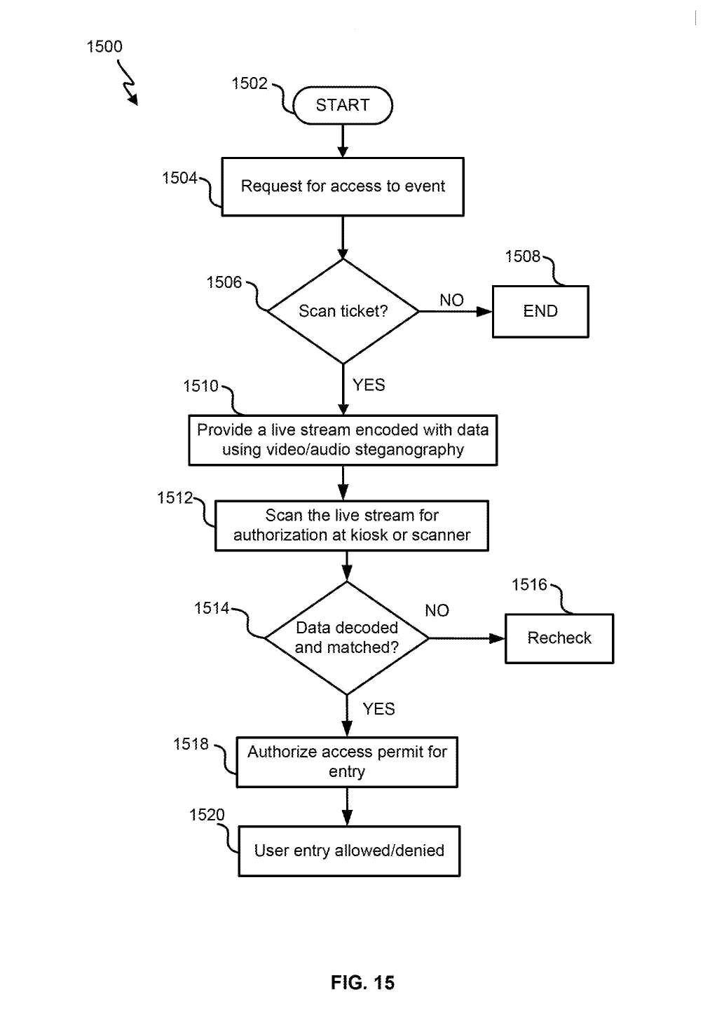

Referring to FIG. 15, illustrates a flowchart describing a process 1500 for authorizing access to a user for entering a venue of an event according to another embodiment of the present disclosure. The process 1500 begins when a user books a ticket for the event and arrives at an entry of the venue. A mobile application or a ticketing application is installed on the end-user device 104 of the user for booking the tickets. At block 1502, the user has purchased tickets for the event via the end-user device 104. At block 1504, request for access to the event is made by the user using the end-user device 104. The ticket purchased by the user is scanned at the venue by a ticket reader or gate keeper using the scanner 114 present at the entrance of the venue.

In another embodiment, the ticket is displayed as a live stream (a video or an audio) on the kiosk. The video or the audio is scanned using the mobile application to authorize the user in the venue.

At block 1506, a determination of the scan of the ticket is detected by the scanner 114 and the signal of detection of the ticket is provided to the access management server 110 at block 1510. Else the process ends at block 1508 if the signal is not detected. At block 1510, the access management server 110 receives the signal, and the user credentials are extracted. The ticket can have a bar code and/or a video or an audio that can store necessary details relating to the authentication of the user at the venue. The user is requested to provide the video or the audio for scanning to the scanner 114 or the user is requested to scan the video or the audio at the kiosk.

At block 1512, the video or the audio is scanned by the scanner 114 or the mobile application of the end-user device 104 and the detected video or the audio is provided to the access management server 110. The access management server 110 receives the scanned video or the audio and processes it. Video steganography or audio steganography is used to encode the video.

At block 1514, the access management server 110 decodes the details of the video or the audio. A determination of the extraction of the data from the ticket is made and if the data is extracted, it is matched with the details stored in the user profiles 714. If the match is successful, then at block 1518, the user is authorized to enter the venue. Else a recheck is performed at block 1516 where the user is requested to scan the ticket again or provide more details to the access management server 110 using the ticketing application on the end-user device 104.

At block 1518, the ticket credentials are verified, authenticated and the access is authorized to the user. The user receives a notification of the grant or denied access to enter the event venue at block 1520. The user enters the venue and joins the event based on the authorization. The user location is tracked continuously to provide recommendations such as ads, nearby stores, shops, or coupons on nearby items in the venue. The recommendations are provided on the ticketing application of the end-user device 104.

In one embodiment, to authenticate the user, the ticket credentials can be sent over to the access management server(s) 110 which can validate the details relating to the ticket and the user to verify whether the user who bought the ticket is trying to enter the venue.

In another embodiment, the ticket credentials are not sent to the access management server 110 and the authentication of the user can be done using one or more biometric sensors present on the end-user device 104 or any computing device present at the venue. However, if the user credentials are not found to be valid, the user is not permitted access inside the venue, and the process ends (block 1508).

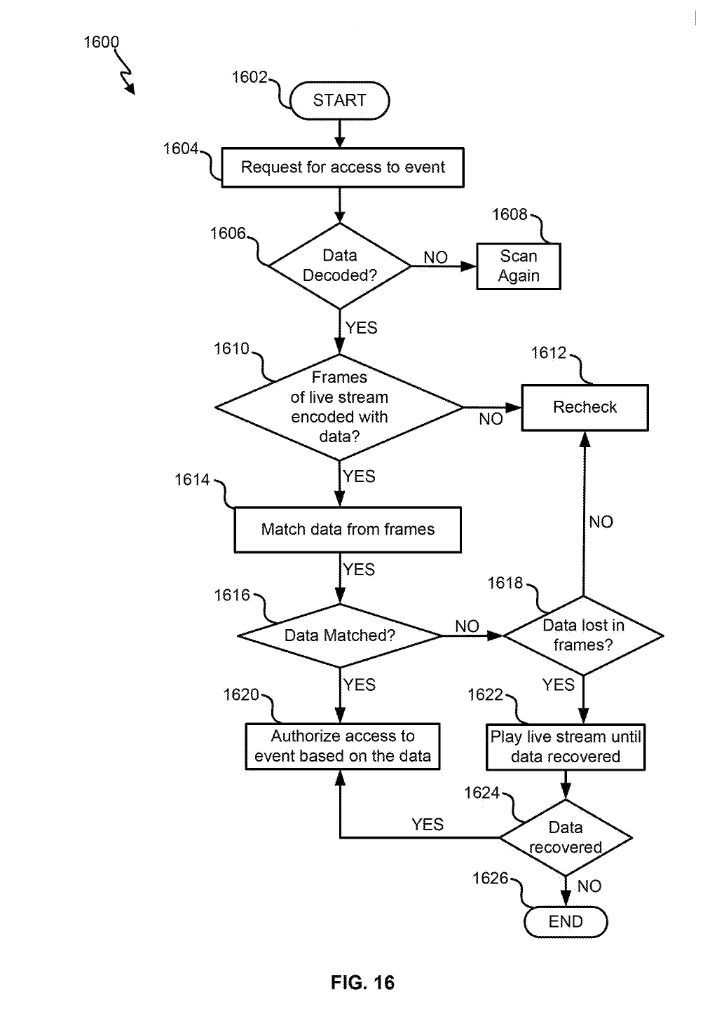

Referring to FIG. 16, illustrates a flowchart of a process 1600 for encoding frames of a live stream (video or audio) to generate encoded data according to another embodiment of the present disclosure. The process begins at block 1602, where a user books and purchases a ticket or an entry token for an event via the end-user device 104 of the user. After purchasing the ticket, the user intends to attend the event and reaches the venue of the event. The ticket is an encoded video or the audio including data. In an embodiment, one or more frames of the video or the audio are encoded with data. In another embodiment, each frame of the video or the audio is encoded with data.

A computer program can extract the data from the video or the audio. The digital fountain includes only parts of the encoded data that are available in any particular frame and only by combining the data could the encoded data be retrieved, in addition to a time synchronized or a rotating barcode. The data in multiple frames of the video or the audio are encoded such that multiple frames of the video or the audio would be entailed in order to extract the data from the video or the audio. The video or the audio may be seconds or minutes in duration or longer and played till the data is encoded in the frames. If some parts of the data are lost, the video or the audio is kept playing so that the data shows up again in the digital fountain.

At block 1604, the user requests entry to the event at the gate or an entrance of the venue by scanning the video or the audio in the ticket at the kiosk. A gate keeper or a ticket collector further scans the video or the audio at the entrance using the scanner 114 in case of error in scanning the video or the audio at the kiosk or verifying the authorization using the scanner 114. The scanner 114 transmits a signal on successful scan of the ticket to the access management server 110 for verifying access to the user. The scanner 114 identifies the ticket by scanning the video or the audio.

At block 1606, the access management server 110 receives the ticket and verifies access to the user by decoding the data in the video or the audio. The data in the video or the audio includes information about the user, booking details, payment, and other user-related information. If the data in the video or the audio is decoded, then at block 1610, data from individual frames are extracted. If the data cannot be decoded then at block 1608, the user is requested to scan the ticket again as the decode of the data has failed.

At block 1610, singular frames from the video or the audio is decoded to extract the data from the frame. The data is quintessential in the validation of the ticket. When the frames of the video or the audio are decoded completely, then at block 1614, the data from the frames are matched with the data retrieved from the user profiles 714. The data may also be directly provided by the event providers to the access management server 110 for matching with the decoded data from the video or the audio. Else if the data is not decoded then at block 1612, a recheck is performed by the access management server 110. The frames are decoded again, and the video or the audio is requested to be scanned again. Due to network issues, the frames may be lost. By checking the network connection and scanning and decoding the video or the audio again, the lost frames can be recovered.

At block 1616, a determination is made whether the data from the video or the audio is matched with the stored data in the access management server 110 or data provided by the event providers. The access right is authorized to allow or deny entry to the event.

If the data is matched, then at block 1620, the user is authorized to enter the event. Else at block 1618 a determination is made whether the data is lost in frames. The ticket is requested for scanning again if the data frames are lost and not recovered after playing the complete video or the audio. At block 1622, the video or the audio continues to be played till the lost frames are recovered.

At block 1620, based on the successful match of the data, the user is authorized to enter the venue. A notification is sent to the user to continue entering the venue. At block 1624, a determination is made whether the data is recovered from the video or the audio, and based on the recovery of the video or the audio, the user is authorized to enter the event at block 1620. Else the user is unauthorized and access to the user in the event is blocked at block 1626.

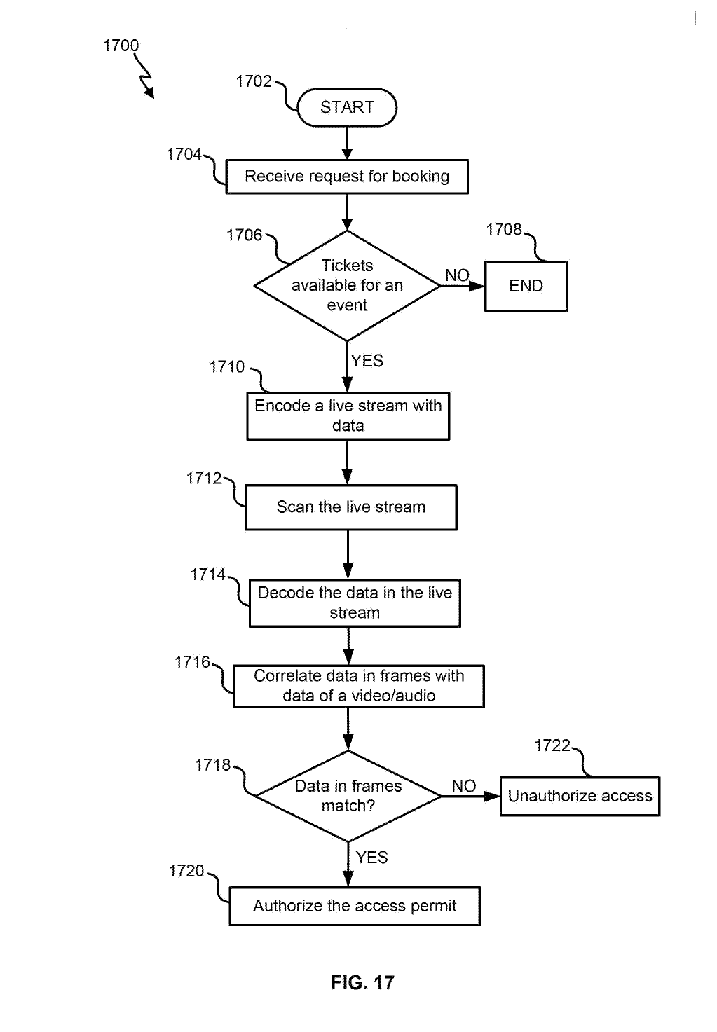

Referring to FIG. 17, illustrates a flowchart of a process 1700 for encoding and decoding data of frames of a live stream (video or audio) according to another embodiment of the present disclosure. The process begins at block 1702, where the user searches for events on a ticketing application or a mobile application installed on the end-user device 104. At block 1704, the user initiates a request to attend an event by selecting an event on the mobile application. The request is sent to the access management server 110 or the event providers.

At block 1706, the access management server 110 determines whether the tickets are available for the event selected by the user. The access management server 110 confirms the availability of the tickets with the event providers as well. The user purchases the tickets and books the seats using the end-user device 104. If the tickets are unavailable, then the user is notified on the end-user device 104 at block 1708.

At block 1710, the access management server 110 encodes data in video or the audio stream, the data pertaining to the ticket. The access management server 110 provides the encoded video or the audio with the data to the user on the mobile application of the end-user device 104. The user is requested to provide the video or the audio for verification when the user attends the event at the venue.

At block 1712, the user receives the encoded video or the audio at an instant of time and provides the video or the audio for scanning at a kiosk or a gate of the entrance while attending the event. Scanners 114 are used by a gate keeper or a ticket collector to scan the video or the audio at the entrance.

At block 1714, the decoder 706 identifies and decodes the data in the video or the audio to acquire information related to the user, payment, and booking details. The information is used to authorize the access to the user.

At block 1716, the information from the video or the audio is correlated by the access management server 110 with the information stored in the user profiles 714 or the information obtained from the event providers at the instant of time. The data from each frame of the video or the audio is correlated with the stored data of the user profiles 714.

At block 1718, a determination is made whether the data from the frames of the video or the audio match with the data from the user profiles 714. Based on the correlation/match, the access management server 110, the access to the event is authorized at block 1720 or unauthorized at block 1722. If the access is authorized, the user can enter the event else the access to the event is blocked for the user.

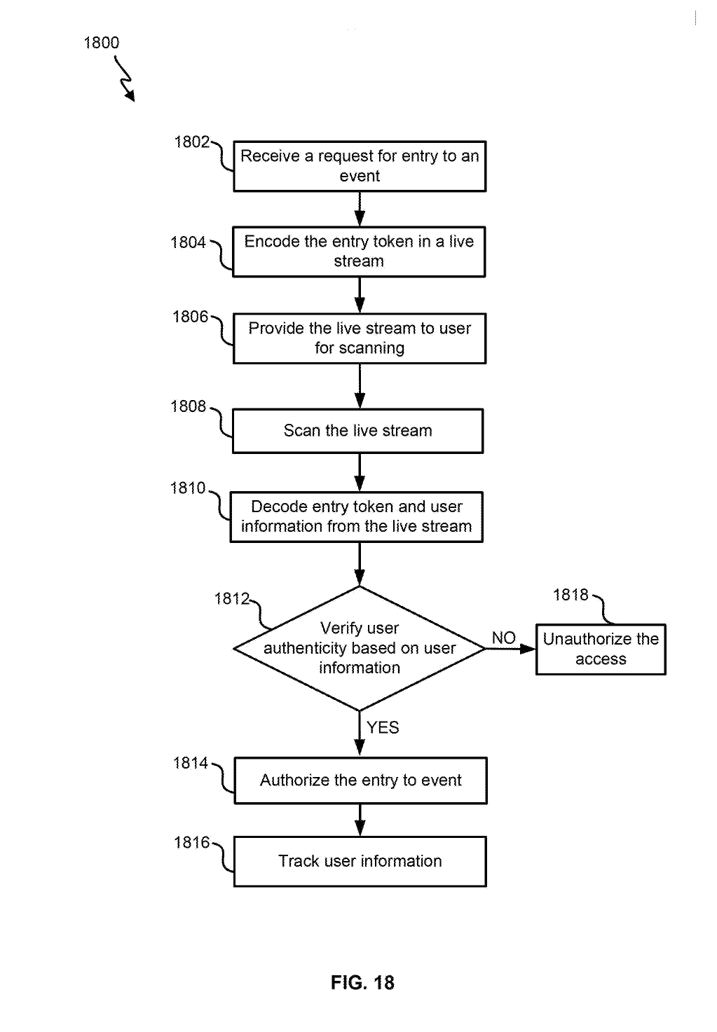

Referring to FIG. 18, illustrates a flowchart of a process 1800 for extracting user information from a live stream (a video or an audio) according to another embodiment of the present disclosure. The process begins at block 1802, where the user initiates booking of tickets for events on a ticketing or mobile application installed on the end-user device 104. The user requests to use the mobile application for entry to an event. The user further requests an entry token from the access management server 110 after booking the ticket.

At block 1804, the access management server 110 encodes data associated with the ticket in the entry token. The data includes user information, payment information, and other booking details of the event. The entry token is a video or the audio stream and the data is encoded in the video or the audio stream.

At block 1806, the user is provided with the entry token on the mobile application of the user. The entry token is presented to a gatekeeper or a ticket collector. The user is requested to present the entry token while entering the venue of the event. The entry token includes the data encoded in the video or the audio stream. The data includes user information.

At block 1808, the gatekeeper or the ticket collector uses the scanner (s) 114 at the gate to scan the entry token presented by the user. The user may be requested to present the entry token at the gate by the gatekeeper or may be notified on the mobile application to scan the video or the audio at the kiosk. The scanner 114 provides the scanned video or the audio stream by the user to the access management server 110 for further processing and analysis.

At block 1810, the entry token is decoded to extract the data from the video or the audio stream. The video or the audio stream is decoded by the access management server 110 and the data is extracted. The entry token includes the user information. The user information includes at least one of a user location, a user position, user preferences, or a network connection. The video or the audio stream is embedded with advertisements along with the data. The user information also includes user details, payment and booking information associated with the current and past events.

At block 1812, the access management server 110 performs the authorization of the user. The access to the user is authorized based on the decoded user information. The user details, payment, and booking information is matched with the user information available from the user profiles 714.

Based on the successful match of the user information and confirmation of the user details, payment, and booking information, the user is authorized at block 1814. If the match fails, the access to the user is not granted at block 1818, and the user is unauthorized. At block 1814, the user continues to enter the event.

At block 1816, the user information is tracked as the user moves inside the venue. The in-venue purchases of the user and the user’s location are continuously tracked for generating recommendations. The in-venue purchases of the user indicate purchasing at the stores present inside the venue. The stores can be food stores, artist/team product franchise stores, other products (such as flags, T-shirts, boards, balloons) stores, etc.

In one embodiment, monitoring the in-venue purchase of the user also indicates monitoring the location of the user to verify that the user is present inside the venue when making the purchase. The in-venue purchase indicates user interests, user preferences, and helps generate recommendations for shopping inside the venue. The recommendations are sent to the user on the end-user device (s) 104 of the user.

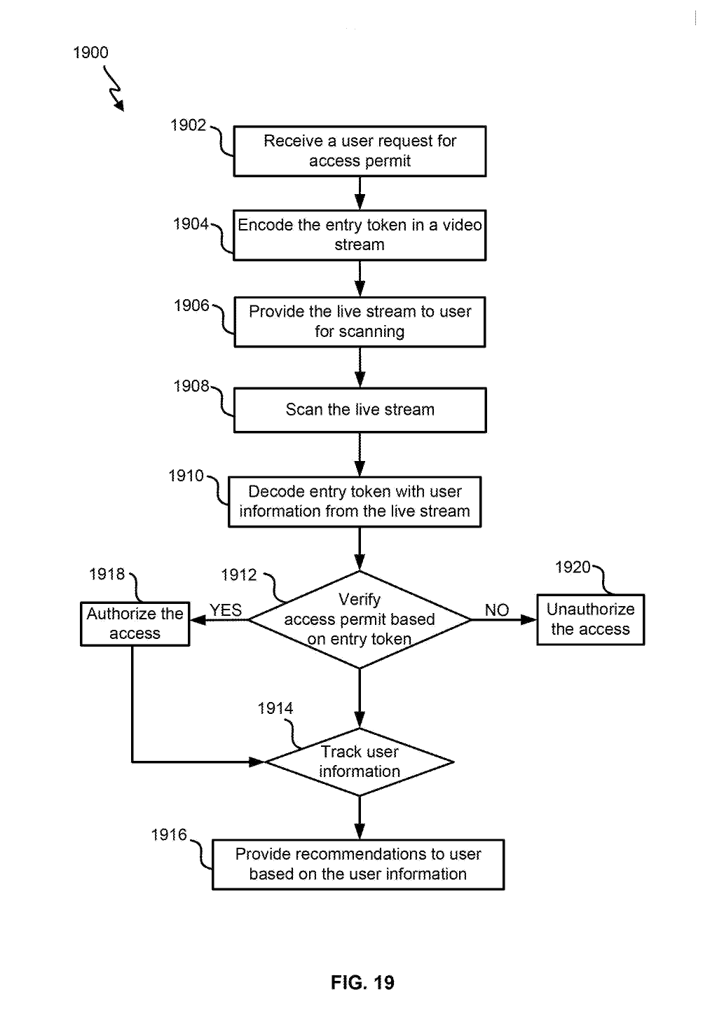

Referring to FIG. 19, illustrates a flowchart of a process 1900 for recommending activities to a user inside a venue according to another embodiment of the present disclosure. The process begins at block 1902 where the user has purchased the tickets for the event and requests for an access right from the access management server 110. An entry token is requested from the access management server 110. At block 1904, the ticket credentials and data associated with the ticket are encoded in the entry token in the form of a video or an audio.

At block 1906, the encoded video or the audio with the data and the ticket credentials are provided by the access management server 110 to the user. The video or the audio may be provided by the event providers to the access management server 110 at an instant of time. The user receives the video or the audio on the mobile application of the end-user device 104. The mobile application is used for booking and purchasing the tickets.

At block 1908, when the user reaches the venue, the user is requested to scan the video or the audio at the kiosk on the mobile application of the end-user device 104. The video or the audio is scanned by the scanners 114 at the gate of the venue on the kiosk or using the mobile application. The scanners 114 send the identified video or the audio to the access management server 110 for decoding and authorization.

At block 1910, the access management server 110 decodes the video or the audio received from the scanners 114. The data in the video or the audio is decoded, and the ticket credentials of the user are validated for authorization of the access right.

At block 1912, it is determined by the access management server 110 whether the ticket credentials are valid based on the entry token. The user information decoded from the video or the audio are correlated with the information stored in the data storage of the access management server 110 or directly provided to the access management server 110 by the event providers at the instant of time. Based on the successful correlation, the access to the user is authorized at block 1918 or if the correlation is unsuccessful, the access is unauthorized at block 1920.

At block 1914, user information is continuously tracked by the access management server 110. For example, user location, user behaviour, and user activities are tracked. The past and present behaviour of the user is monitored. The behaviour of the user can be monitored from the time the entry token is assigned to the user. Based on the past and present behaviour of the user, the user can be recommended with one or more activities, at block 1916. The behaviour of the user can include events attended by the user, the type of seats assigned to the user while attending the event, favourite performers/artists of the user, etc. Future events can include recommendations to the user regarding future events, shopping stores, discounts, advertisements to be played with the video or the audio or on the mobile application, future venues based on the past and present behaviour of the user.

Moreover, when it is determined by the access management server 110 that the in-venue purchase did not occur, the venue management device(s) 102 encourages the user to make more purchases inside the venue. For achieving this, the user is provided with promotional offers on their end-user devices 104. These promotional offers can be provided by the stores present inside the venue.

In one embodiment, the offers are transmitted to the user in real-time. For example, the stores can transmit offers such as “buy anything within the next 15 minutes and get a 50% discount”. Such offers would encourage the user to rush to the store to buy something so that they can be rewarded with the discount.

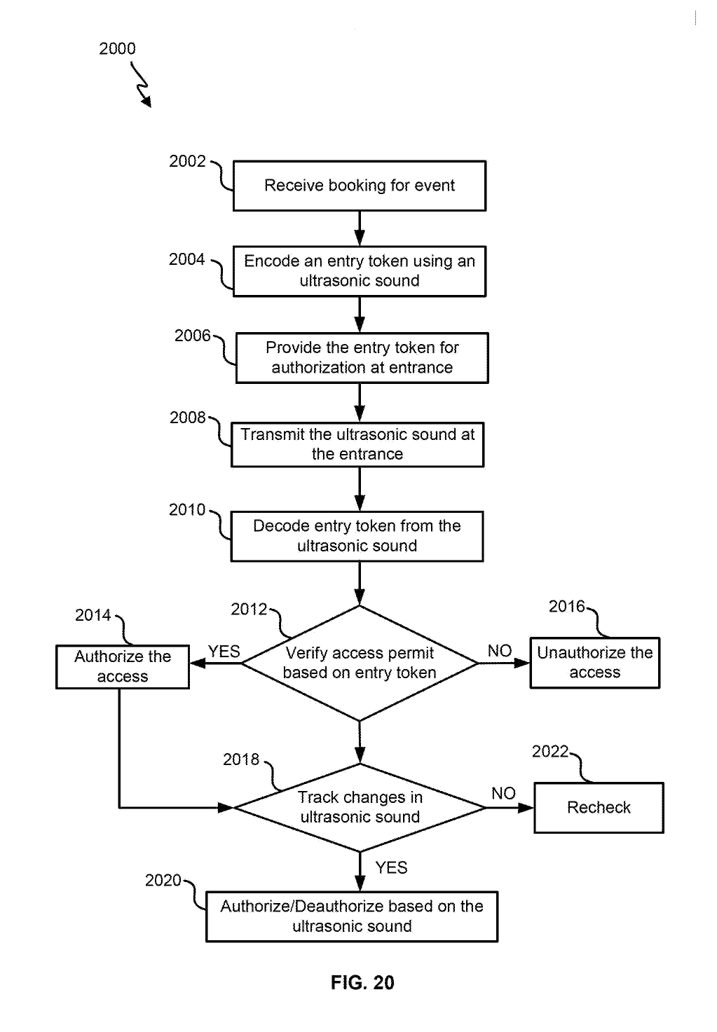

Referring to FIG. 20, illustrates a flowchart of a process 2000 for using ultrasonic sounds as entry token to authorize the user according to another embodiment of the present disclosure. The entry token includes the ultrasonic signals used for scanning the entry token at a gate entrance or kiosk of the venue of an event. The process begins at block 2002 where the user initiates a booking of the event using the mobile application installed on the end-user device 104. The user confirms the booking of a ticket to the event by making payment for the ticket. The user requests for an entry token that is scanned for authorization at the gate entrance of the event.

At block 2004, the access management server 110 receives the booking request and the payment details and encodes an entry token containing the data associated with the user, booking and payment details. The data is encoded in the entry token using the ultrasonic signals.

At block 2006, the access management server 110 provides the entry token to the user on the mobile application of the end-user device 104. The user is requested to provide the entry token for authorization at the gate of the venue.

At block 2008, the user is requested to scan the entry token at the gate or the kiosk by a gate keeper or a ticket collector. The gate keeper has the scanner 114 that detects the ultrasonic signals from the entry token. The ultrasonic signal is transmitted by presenting the entry token to the scanner 114. The ultrasonic signal is detected at the entrance using the scanner 114.

At block 2010, the access management server 110 decodes data from the entry token and acquires the user information, booking and payment details from the entry token. The data is further verified by the access management server 110 for validation of the ticket and granting access to the user based on the verified data.

At block 2012, the user information is matched with the user information available in the user profiles 714. The booking and payment details are confirmed with the event providers. After the match of the user information is successful and the booking and payment details are confirmed, the user is authorized to enter the venue for the event at block 2014 else if any of the details or information is not matched and found invalid, then the user is unauthorized to enter the venue at block 2016.

At block 2018, the changes in the ultrasonic sound are tracked as the user enters the venue. If a change in a level of the ultrasonic sound is detected then at block 2020, the user is re-authorized based on identifying the current location and position of the user. The user may be requested to get the ticket scanned again and re-authorize the access. If no changes in the ultrasonic sound is detected then at block 2022, changes in the ultrasonic sound are monitored continuously. The changes in the ultrasonic sound indicate a change in user location. The monitoring of the user location is beneficial in identifying user purchases, user interests in stores nearby, food items or user preferences which facilitate the access management server 110 to generate recommendations for the user.

In one embodiment, the access management server 110 provides additional priority/discounts to users based on their booking in the organizer's suggested seats, hotels, and parking. The access management server 110 incentivizes users to book recommended accommodations and parking options that offer additional rewards such as proximity to celebrities or players attending the event.

As described in further detail below, in some instances, the access management server 110 includes a database of recommended hotels and parking options that the organizer has suggested to users. The access management server 110 also includes a prioritization algorithm that assigns priority levels to each recommended hotel and parking option based on proximity to celebrities or players, availability, and other factors. The prioritization algorithm uses the user location to generate priority levels and assign recommendations. The access management server 110 sends personalized messages to users, informing them of the additional priority/discounts they can receive by booking recommended accommodations and parking options.

Moreover, the users who book recommended accommodations, and parking options receive additional priority/discounts such as early check-in, late check-out, free parking, or access to limited-access events. The priority/discounts are based on the priority level of the booked accommodation or parking option.

In addition, the system continuously updates the prioritization algorithm based on feedback from users, availability of recommended accommodations and parking options, and other factors.

In various embodiments, the access management server 110 incentivizes users to book recommended accommodations, purchase in recommended stores, and choose parking options, which eventually leads to a better overall experience for the user.

In one exemplary embodiment, the access management server 110 is adapted for identifying user interests in particular players, teams, and fan clubs.

An exemplary embodiment illustrates a computer-implemented system that collects data on user activity, social media presence, and purchase history. The system then uses machine learning algorithms to analyse the data and calculate an index value for individual user in the event and provide the users with recommendations and feedback.

In another embodiment, the access management server 110 includes a notification feature that alerts users when a ticket becomes available within the fan club group. This feature allows users to acquire tickets quickly and easily for events they are interested in attending.

In one exemplary embodiment, the access management server 110 is adapted for offering surrendered event tickets to users based on their preferences. The access management server 110 collects event preferences from users, including their favourable events, location, time, etc. When a ticket is surrendered, the access management server 110 matches the event details with the preferences of the users in its database. If a match is found, the access management server 110 offers the surrendered ticket to the user.

In another embodiment, the access management server 110 can prioritize the offer based on the user's preferences. For example, if a user's favourable event is a concert by a particular artist, and a ticket for that concert is surrendered, the access management server 110 will prioritize offering the ticket to that user over others.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, non-volatile, or other storage medium and is not to be limited to any particular type of memory or number of memories, or type of media upon which memory is stored.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. Moreover, as disclosed herein, the term "storage medium" may represent one or more memories for storing data, including read only memory (ROM), random access memory (RAM), magnetic RAM, core memory, magnetic disk storage mediums, optical storage mediums, flash memory devices and/or other machine readable mediums for storing information. The term "machine-readable medium" includes, but is not limited to portable or fixed storage devices, optical storage devices, and/or various other storage mediums capable of storing that contain or carry instruction(s) and/or data. These machine-readable instructions may be stored on one or more machine-readable mediums, such as CD-ROMs or other type of optical disks, solid-state drives, tape cartridges, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Implementation of the techniques, blocks, steps, and means described above may be done in various ways. For example, these techniques, blocks, steps, and means may be implemented in hardware, software, or a combination thereof. For a digital hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. For analog circuits, they can be implemented with discreet components or using monolithic microwave integrated circuit (MMIC), radio frequency integrated circuit (RFIC), and/or micro electro-mechanical systems (MEMS) technologies.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

While the principles of the disclosure have been described above in connection with specific apparatuses and methods, it is to be clearly understood that this description is made only by way of example and not as limitation on the scope of the disclosure.

What is claimed is:

1. An event management system for providing access rights to users based on streams encoded with information for access to events, comprising:
an access management server configured to:
receive, over a network, a request send using a system application of a user device for an access right for an event;
provide to the user device, a notification to scan the access right, wherein the access right is an entry token associated with access right for an entry to the event, the entry token has data encoded in a stream; and
enable the system application of the user device to scan the stream for authorization at a venue entrance of the event;
decode the data encoded in the stream scanned using the system application of the user device; and
authorize the access right for the request based on information decoded from the stream for the entry to the event.

2. The event management system of claim 1, wherein the stream includes a video or an audio, and the video or the audio is encoded with real-time user information and kiosk location using video steganography or audio steganography, respectively.

3. The event management system of claim 1, wherein the event management system further includes:
a scanner located adjacent to the venue entrance and the scanner is coupled to the access management server, wherein:
the scanner is configured to scan the stream provided by the user device, and
the stream is provided to the user device by the access management server.

4. The event management system of claim 1, wherein:
one or more frames of the stream are encoded with a portion of data at an instant of time, and a plurality of frames of the stream are encoded with the data,
the plurality of frames are decoded to extract the data,
the stream is a live video or a real-time audio,
the access management server is further configured to correlate the data decoded from the plurality of frames of the stream with the data from a number of frames of a video or an audio received by the access management server at the instant of time, and
authorize the access right for the user based on the correlation for the entry to the event.

5. The event management system of claim 1, wherein:
the entry token includes user information and an authorization for the entry to the event from the venue entrance,
the user information includes at least one of user location, user position, user preferences, or network connection, and the stream is embedded with advertisements with the data, and
the advertisements are based on the user information.

6. The event management system of claim 5, wherein recommendations to the user are provided on the user device based on the user information, and the recommendations include stores, coupons, outlets, and discounts on purchases from the stores located at the user location in the event.

7. The event management system of claim 1, wherein:
the entry token is encoded using an ultrasonic sound,
the user device is enabled to transmit the ultrasonic sound associated with the entry token for scanning and authorization at the venue entrance;
a scanner is configured to scan the ultrasonic sound provided by the user device,
the entry token encoded using the ultrasonic sound is decoded, and
the access right is authorized for the user based on the decoded entry token for the entry to the event.

8. A method for providing access rights to users based on live streams encoded with information for access to events, the method comprising:
receiving, by an access management server, over a network, a request send using a system application of a user device for an access right for an event;
providing, by the access management server to the user device, a notification to scan the access right, wherein the access right is an entry token associated with access right for an entry to the event, the entry token has data encoded in a live stream; and
enabling, by the access management server, the system application of the user device to scan the live stream for authorization at a venue entrance of the event;
decoding, by the access management server, the data encoded in the live stream scanned using the system application of the user device; and
authorizing, by the access management server, the access right for the request based on information decoded from the live stream for the entry to the event.

9. The method of claim 8, wherein the live stream includes a video or an audio, and the video or the audio is encoded with real-time user information and kiosk location using video steganography or audio steganography, respectively.

10. The method of claim 8, wherein the method further comprising:
a scanner located adjacent to the venue entrance and the scanner is coupled to the access management server, and
scanning, using the scanner, the live stream provided by the user device,
the live stream is provided to the user device by the access management server.

11. The method of claim 8, wherein:
one or more frames of the live stream are encoded with a portion of data at an instant of time, and a plurality of frames of the live stream are encoded with the data,
the plurality of frames are decoded to extract the data,
the live stream is a live video or a real-time audio,
the access management server correlates the data decoded from the plurality of frames of the live stream with the data from a number of frames of a video or an audio received by the access management server at the instant of time, and
the access right is authorized for the user based on the correlation for the entry to the event.

12. The method of claim 8, wherein:
the entry token includes user information and an authorization for the entry to the event from the venue entrance,
the user information includes at least one of user location, user position, user preferences, or network connection, and the live stream is embedded with advertisements with the data, and
the advertisements are based on the user information.

13. The method of claim 12, wherein recommendations to the user are provided on the user device based on the user information, and the recommendations include stores, coupons, outlets, and discounts on purchases from the stores located at the user location in the event.

14. The method of claim 8, wherein:
the entry token is encoded using an ultrasonic sound,
the user device is enabled to transmit the ultrasonic sound associated with the entry token for scanning and authorization at the venue entrance;
a scanner is configured to scan the ultrasonic sound provided by the user device,
the entry token encoded using the ultrasonic sound is decoded, and
the access right is authorized for the user based on the decoded entry token for the entry to the event.

15. A non-transitory computer-readable medium containing instructions that, when executed by a processor, cause the processor to perform a method for providing access rights to users based on live streams encoded with information for access to events, the method comprising:
receiving, by an access management server, over a network, a request send using a system application of a user device for an access right for an event;
providing, by the access management server to the user device, a notification to scan the access right, wherein the access right is an entry token associated with access right for an entry to the event, the entry token has data encoded in a live stream; and
enabling, by the access management server, the system application of the user device to scan the live stream for authorization at a venue entrance of the event;
decoding, by the access management server, the data encoded in the live stream scanned using the system application of the user device; and
authorizing, by the access management server, the access right for the request based on information decoded from the live stream for the entry to the event.

16. The non-transitory computer-readable medium of claim 15, wherein the live stream includes a video or an audio, and the video or the audio is encoded with real-time user information and kiosk location using video steganography or audio steganography, respectively.

17. The non-transitory computer-readable medium of claim 15, wherein the method further comprising:
a scanner located adjacent to the venue entrance and the scanner is coupled to the access management server, and
scanning, using the scanner, the live stream provided by the user device,
the live stream is provided to the user device by the access management server.

18. The non-transitory computer-readable medium of claim 15, wherein:
one or more frames of the live stream are encoded with a portion of data at an instant of time, and a plurality of frames of the live stream are encoded with the data,
the plurality of frames are decoded to extract the data,
the live stream is a live video or a real-time audio,
the access management server correlates the data decoded from the plurality of frames of the live stream with the data from a number of frames of a video or an audio received by the access management server at the instant of time, and
the access right is authorized for the user based on the correlation for the entry to the event.

19. The non-transitory computer-readable medium of claim 15, wherein:
the entry token includes user information and an authorization for the entry to the event from the venue entrance,
the user information includes at least one of user location, user position, user preferences, or network connection, and the live stream is embedded with advertisements with the data, and
the advertisements are based on the user information.

20. The non-transitory computer-readable medium of claim 19, wherein recommendations to the user are provided on the user device based on the user information, and the recommendations include stores, coupons, outlets, and discounts on purchases from the stores located at the user location in the event.
